(19) United States
(12) Patent Application Publication
(10) Pub. No.: US 2025/0089112 A1
(43) Pub. Date: Mar. 13, 2025

(54) MANAGING MASTER NODE COMMUNICATION IN DUAL CONNECTIVITY AND NON-DUAL CONNECTIVITY

(71) Applicant: GOOGLE LLC, Mountain View, CA (US)

(72) Inventor: Chih-Hsiang Wu, Taoyuan City (TW)

(21) Appl. No.: 18/727,334

(22) PCT Filed: Jan. 6, 2023
(86) PCT No.: PCT/US23/10307

§ 371 Date: Jul. 8, 2024

(51) Int. Cl. H04W 76/15; H04W 36/36

(52) U.S. Cl. CPC H04W 76/15; H04W 36/362

(57) ABSTRACT

A central unit (CU) of a disaggregated base station including the CU and a distributed unit (DU) can implement a method for managing multi-connectivity coordination information. The method may include: receiving, from a candidate secondary node, multi-connectivity coordination information for a candidate cell to which a UE connects subject to a condition of a conditional procedure, the multi-connectivity coordination information coordinating usage of radio resources between a cell of the DU and the candidate cell when the CU and the candidate secondary node provide dual connectivity (DC) to the UE; receiving an indication that the UE connected to the candidate cell to use as a secondary cell; and, in response to the receiving of the indication, causing the DU to apply the multi-connectivity coordination information.

### FIELD OF THE DISCLOSURE

This disclosure relates generally to wireless communications and, more particularly, to managing master node communication in dual connectivity and non-dual connectivity for immediate or conditional configurations for multi-connectivity such as secondary node addition or change procedures.

### BACKGROUND

This background description is provided for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

In telecommunication systems, a user equipment (UE) sometimes can concurrently utilize resources of multiple radio access network (RAN) nodes, such as base stations or components of a disaggregated base station (also referred to as a distributed base station), interconnected by a backhaul. When these network nodes support different radio access technologies (RATs), this type of connectivity is referred to as Multi-Radio Dual Connectivity (MR-DC). When a UE operates in MR-DC, one base station operates as a master node (MN) that covers a primary cell (PCell), and the other base station operates as a secondary node (SN) that covers a primary secondary cell (PSCell). The UE communicates with the MN (via the PCell) and the SN (via the PSCell). In other scenarios, the UE transfers a wireless connection from one base station to another base station. For example, a serving base station can determine to hand the UE over to a target base station and initiate a handover procedure.

3GPP specification TS 37.340 v16.6.0 describes procedures for a UE to add or change an SN in DC scenarios. These procedures involve messaging (e.g., RRC signaling and preparation) between radio access network (RAN) nodes. This messaging generally causes latency, which in turn increases the probability that the SN addition or SN change procedure will fail. These legacy procedures, which do not involve conditions that are checked at the UE, can be referred to as “immediate” SN addition and SN change procedures.

More recently, for both SN or PSCell addition/change, “conditional” procedures have been considered (i.e., conditional SN or PSCell addition/change). Unlike the “immediate” procedures discussed above, these procedures do not add or change the SN or PSCell, or perform the handover, until the UE determines that a condition is satisfied. As used herein, the term “condition” may refer to a single, detectable state or event (e.g., a particular signal quality metric exceeding a threshold), or to a logical combination of such states or events (e.g., “Condition A and Condition B.” or “(Condition A or Condition B) and Condition C”, etc.).

To configure a conditional procedure, the RAN provides the condition to the UE, along with a configuration (e.g., one or more random-access preambles, etc.) that will enable the UE to communicate with the appropriate base station, or via the appropriate cell, when the condition is satisfied. For a conditional addition of a base station as an SN or a candidate cell as a PSCell, for example, the RAN provides the UE with a condition to be satisfied before the UE can add that base station as the SN or that candidate cell as the PSCell, and a configuration that enables the UE to communicate with that base station or PSCell after the condition has been satisfied.

In the immediate PSCell addition or change procedure, the RAN (i.e., MN or SN) transmits an RRC reconfiguration message including multiple configuration parameters to the UE and the UE attempts to connect to a (target) PSCell configured by the RRC reconfiguration message. After the UE successfully connects to the SN via the PSCell, the UE communicates with the SN on the PSCell by using the multiple configuration parameters and security key(s) associated to the PSCell and derived from one or more security configuration parameters in the RRC reconfiguration message. The SN also derives security key(s) which match the security key(s) derived from the UE. After the UE successfully connects to the PSCell, the RAN (e.g., the SN) communicates data with the UE by using the matching security key(s) and the multiple configuration parameters.

In some cases, a candidate SN (C-SN) can provide multiple candidate configurations when, for example, multiple candidate PSCells are available. When the MN completes the preparation for a conditional SN procedure (e.g., conditional SN addition or conditional SN cell change), the MN at this time cannot determine which candidate secondary cell the UE will connect to in the future. Moreover, because the UE connects to the secondary cell only subject to the fulfillment of one or more conditions, the MN cannot determine whether the UE will even connect to any of the candidate cells in the future.

Conditional SN procedures present certain challenges for coordinating usage of radio resources between an MN and an SN in a correct and timely manner. Coordination can involve selecting power or discontinuous reception (DRX) parameters at the MN in view of the SN, for example, or limiting uplink power of the UE when transmitting to the MN in view of any overlapping uplink transmission to the SN. Furthermore, when the MN includes a central unit (CU) and a distributed unit (DU), it is unknown how the CU controls the DU to select power or DRX parameters.

### SUMMARY

A distributed unit (DU) of a disaggregated base station of this disclosure applies coordination information for coordinating and/or restricting usage of power or frequency resources when a UE connects to a secondary cell for communicating in dual connectivity (DC) subject to one or more conditions of a conditional procedure. The conditional procedure can be for example conditional PSCell addition or conditional PSCell change. To support the application of coordination information, the CU of the disaggregated base station obtains the coordination information from a secondary node, which can be another base station or another DU of the disaggregated base station, and causes the DU to apply the coordination information after the one or more conditions are satisfied, and the UE connects to the candidate secondary cell (which begins to operate as the secondary cell).

In some cases, the CU receives a list of candidate cells and the corresponding coordination information, stores the coordination information until the UE connects to one of the candidate secondary cells, and transmits to the UE only the coordination information related to the secondary cell. In another implementation, the CU transmits the list including respective coordination information for multiple candidate cells, and then instructs the DU to discard any coordination information that is no longer relevant. More particularly, after the UE connects to one of the candidate cells, the CU instructs the DU to discard the coordination information for the remainder of the candidate cell list.

In one example embodiment of this disclosure, a central unit (CU) of a disaggregated base station including the CU and a distributed unit (DU) can implement a method for managing multi-connectivity coordination information. The method can be implemented by processing hardware and may include: receiving, from a candidate secondary node, multi-connectivity coordination information for a candidate cell to which a UE connects subject to a condition of a conditional procedure, the multi-connectivity coordination information coordinating usage of radio resources between a cell of the DU and the candidate cell when the CU and the candidate secondary node provide dual connectivity (DC) to the UE; receiving an indication that the UE connected to the candidate cell for use as a secondary cell; and, in response to receiving the indication, causing the DU to apply the multi-connectivity coordination information.

In another example embodiment of this disclosure, a distributed unit (DU) of a disaggregated base station including the DU and a central unit (CU) can implement a method for managing multi-connectivity coordination information. The method can be implemented by processing hardware and may include: receiving, from the CU and for a UE operating in a cell of the DU, a radio resource control (RRC) reconfiguration message including information for connecting to a cell of a candidate secondary node subject to a condition of a conditional procedure; transmitting the RRC reconfiguration message to the UE; receiving, from the CU, multi-connectivity coordination information coordinating usage of radio resources between the cell of the DU and the cell of the candidate secondary node; and applying the multi-connectivity coordination information at the DU, in response to determining that the UE connected to the cell of the candidate secondary node.

### BRIEF DESCRIPTION OF THE DRAWINGS

FIG. 1A is a block diagram of an example system in which a base station and/or a user equipment (UE) can implement the techniques of this disclosure for managing conditional procedures related to a master node (MN) or a secondary node (SN);

FIG. 1B is another block diagram of an example system in which a radio access network (RAN) and a user device can implement the techniques of this disclosure for managing conditional procedures related to an MN or an SN;

FIG. 1C is a block diagram of an example base station including a central unit (CU) and a distributed unit (DU) that can operate in the system of FIG. 1A or FIG. 1B;

FIG. 2A is a block diagram of an example protocol stack according to which the UE of FIGS. 1A-1B can communicate with base stations;

FIG. 2B is a block diagram of an example protocol stack according to which the UE of FIG. 1A can communicate with a DU and a CU of a base station;

FIG. 3A is a messaging diagram of an example scenario where an MN receives and processes one or more SN configurations from a C-SN during a Conditional SN Addition procedure;

FIG. 3B is a messaging diagram of an example scenario where an MN receives and processes one or more SN configurations from a C-SN during an MN-initiated Conditional SN Change procedure;

FIG. 3C is a messaging diagram of an example scenario where an MN receives and processes one or more SN configurations from a C-SN during an SN-initiated Conditional SN Change scenario;

FIG. 4 is a messaging diagram of an example scenario similar to the scenarios of FIGS. 3A-3C, except that a single base station operating as both the MN and the SN performs the Conditional SN Addition or Change procedure;

FIG. 5 is a flow diagram of an example method where a CU of an MN receives a conditional configuration during a conditional procedure with a C-SN and later transmits multi-connectivity coordination information to a DU;

FIG. 6 is a flow diagram of an example method similar to the method of FIG. 5, but where the CU receives multiple conditional configurations for multiple respective candidate cells of the C-SN and identifies which multi-connectivity coordination information to transmit to the DU based on to which candidate cell the UE has connected;

FIG. 7 is a flow diagram of an example method where a CU of MN that performs an SN procedure determines when to transmit multi-connectivity coordination information to a DU based on whether the SN procedure is a conditional SN procedure or an immediate SN procedure;

FIGS. 8-10 are similar to the methods of FIGS. 5-7, respectively, except where a single base station operates as the MN and the SN;

FIG. 11 is a flow diagram of an example method where a CU notifies a DU to apply multi-connectivity coordination for a RAN node and later instructs the DU to release the multi-connectivity coordination information after or in response to releasing the RAN node;

FIG. 12 is a flow diagram of an example method for managing multi-connectivity information, which can be implemented in a CU; and

FIG. 13 is a flow diagram of an example method for managing multi-connectivity information, which can be implemented in a DU.

### DETAILED DESCRIPTION OF THE DRAWINGS

As discussed in detail below, a UE and/or one or more base stations can use the techniques of this disclosure to manage conditional procedures, such as conditional PSCell addition or change (CPAC). This disclosure may also refer to a conditional PSCell addition procedure and a conditional PSCell change procedure separately using the acronyms CPA and CPC, respectively. Further, base stations can use the techniques of this disclosure to manage multi-connectivity coordination information to support multi-connectivity. This multi-connectivity coordination information may include parameters for the MN and SN to coordinate frequency bands, transmission timing, power control, signal directionality, and other wireless communication aspects. The multi-connectivity coordination information may additionally or alternatively include restriction information to, for example, limit maximum power levels for uplink power control at a connected RAN node.

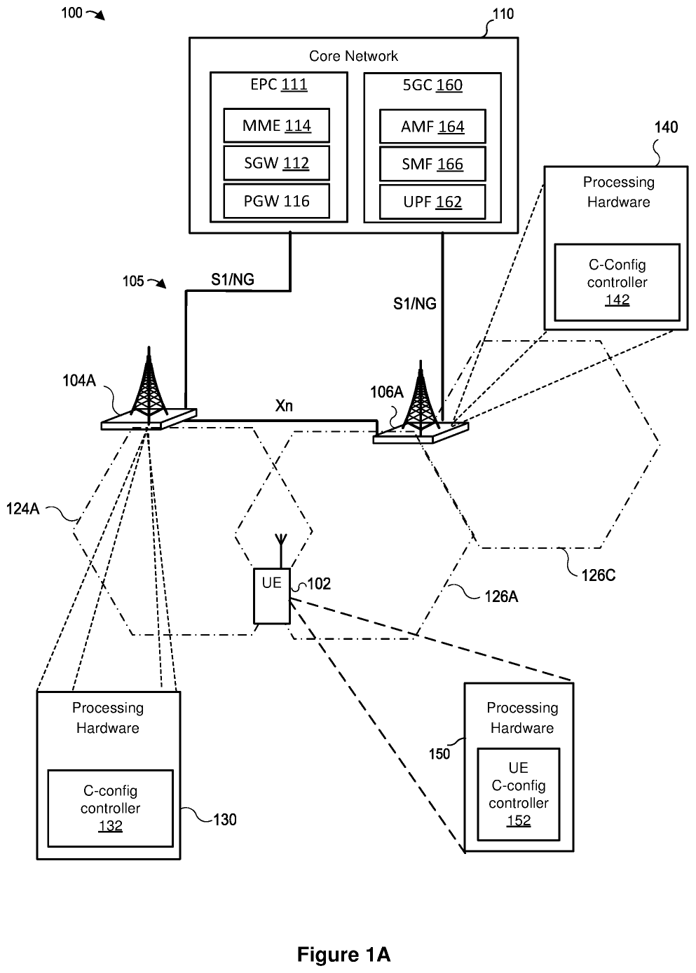

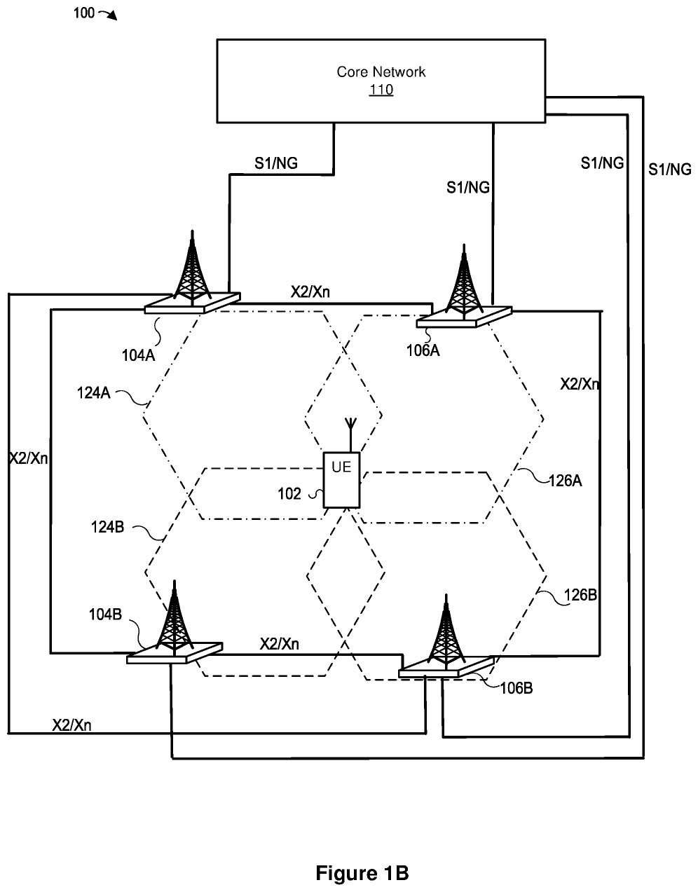

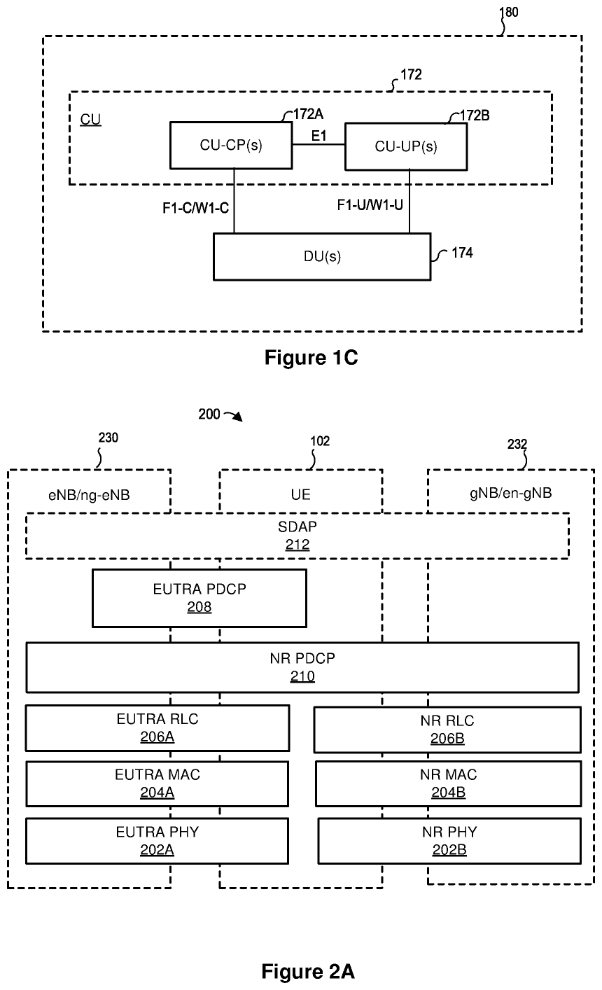

Referring first to FIG. 1A, an example wireless communication system 100 includes a UE 102, a base station (BS) 104A, a base station 106A, and a core network (CN) 110. The base stations 104A and 106A can operate in a RAN 105 connected to the same core network (CN) 110. The CN 110 can be implemented as an evolved packet core (EPC) 111 or a fifth generation (5G) core (5GC) 160, for example.

Among other components, the EPC 111 can include a Serving Gateway (SGW) 112, a Mobility Management Entity (MME) 114, and a Packet Data Network Gateway (PGW) 116. The SGW 112 in general is configured to transfer user-plane packets related to audio calls, video calls, Internet traffic, etc., and the MME 114 is configured to manage authentication, registration, paging, and other related functions. The PGW 116 provides connectivity from the UE to one or more external packet data networks, e.g., an Internet network and/or an Internet Protocol (IP) Multimedia Subsystem (IMS) network. The 5GC 160 includes a User Plane Function (UPF) 162 and an Access and Mobility Management Function (AMF) 164, and/or Session Management Function (SMF) 166. Generally speaking, the UPF 162 is configured to transfer user-plane packets related to audio calls, video calls, Internet traffic, etc.; the AMF 164 is configured to manage authentication, registration, paging, and other related functions; and the SMF 166 is configured to manage PDU sessions.

As illustrated in FIG. 1A, the base station 104A supports a cell 124A, and the base station 106A supports a cell 126A. Further, each of the base stations 104A, 106A may support more than one cell. The base station 106A, for example, may also support a cell 126C. The cells 124A and 126A can partially overlap, so that the UE 102 can communicate in DC with the base station 104A and the base station 106A operating as a master node (MN) and a secondary node (SN), respectively. To directly exchange messages during DC scenarios and other scenarios discussed below, the MN 104A and the SN 106A can support an X2 or Xn interface. In general, the CN 110 can connect to any suitable number of base stations supporting NR cells and/or EUTRA cells. An example configuration in which the EPC 110 is connected to additional base stations is discussed below with reference to FIG. 1B.

The base station 104A is equipped with a transceiver and processing hardware 130 that can include one or more general-purpose processors such as CPUs and non-transitory computer-readable memory storing machine-readable instructions executable on the one or more general-purpose processors, and/or special-purpose processing units. The processing hardware 130 in an example implementation includes a conditional configuration controller 132 configured to manage conditional configuration for one or more conditional procedures such as Conditional Handover (CHO), Conditional PSCell Addition or Change (CPAC), or Conditional SN Additional or Change (CSAC), when the base station 104A operates as an MN.

The base station 106A is equipped with a transceiver and processing hardware 140 that can also include one or more general-purpose processors such as CPUs and non-transitory computer-readable memory storing machine-readable instructions executable on the one or more general-purpose processors, and/or special-purpose processing units. The processing hardware 140 in an example implementation includes a conditional configuration controller 142 configured to manage conditional configurations for one or more conditional procedures such as CHO, CPAC, or CSAC, when the base station 106A operates as an SN.

Still referring to FIG. 1A, the UE 102 is equipped with a transceiver and processing hardware 150 that can include one or more general-purpose processors such as CPUs and non-transitory computer-readable memory storing machine-readable instructions executable on the one or more general-purpose processors, and/or special-purpose processing units. The processing hardware 150 in an example implementation includes a UE conditional configuration controller 152 configured to manage conditional configuration for one or conditional procedures.

More particularly, the conditional configuration controllers 132, 142, and 152 can implement at least some of the techniques discussed with reference to the messaging and flow diagrams below. Although FIG. 1A illustrates the conditional configuration controllers 132 and 142 as separate components, in at least some of the scenarios the base stations 104A and 106A can have similar implementations and in different scenarios operate as MN or SN nodes. In these implementations, each of the base stations 104A and 106A can implement both the conditional configuration controller 132 and the conditional configuration controller 142 to support MN and SN functionality, respectively.

In operation, the UE 102 can use a radio bearer (e.g., a DRB or an SRB) that at different times terminates at the MN 104A or the SN 106A. The UE 102 can apply one or more security keys when communicating on the radio bearer, in the uplink (from the UE 102 to a BS) and/or downlink (from a base station to the UE 102) direction. The UE in some cases can use different RATs to communicate with the base stations 104A and 106A. Although the examples below may refer specifically to specific RAT types, 5G NR or EUTRA, in general the techniques of this disclosure also can apply to other suitable radio access and/or core network technologies.

FIG. 1B depicts additional base stations 104B and 106B, which may be included in the wireless communication system 100. The UE 102 initially connects to the base station 104A. The BSs 104B and 106B may have similar processing hardware as the base station 106A. The UE 102 initially connects to the base station 104A.

In some scenarios, the base station 104A can perform immediate SN addition to configure the UE 102 to operate in dual connectivity (DC) with the base station 104A (via a PCell) and the base station 106A (via a PSCell other than cell 126A). The base stations 104A and 106A operate as an MN and an SN for the UE 102, respectively. The UE 102 in some cases can operate using the MR-DC connectivity mode, e.g., communicate with the base station 104A using 5G NR and communicate with the base station 106A using EUTRA, or communicate with the base station 104A using EUTRA and communicate with the base station 106A using 5G NR. Multi-connectivity coordination can help the two base stations coordinate shared UE capabilities including operational frequencies (e.g., band combinations, frequency ranges), UE measurements and reporting (e.g., intra-frequency measurements, inter-frequency measurements, inter-RAT measurements, measurement gaps), reception timing (e.g., DRX configurations, offset timing), and uplink power control (e.g., power headroom, maximum transmit power).

At some point, the MN 104A can perform an immediate SN change to change the SN of the UE 102 from the base station 106A (source SN, or “S-SN”) to the base station 104B (target SN, or “T-SN”) while the UE 102 is communicating in DC with the MN 104A and the S-SN 106A. In another scenario, the SN 106A can perform an immediate PSCell change to change the PSCell of the UE 102 to the cell 126A. In one implementation, the SN 106A can transmit a configuration changing the PSCell to cell 126A to the UE 102 via a signaling radio bearer (SRB) (e.g., SRB3) for the immediate PSCell change. In another implementation, the SN 106A can transmit a configuration changing the PSCell to the cell 126A to the UE 102 via the MN 104A for the immediate PSCell change. The MN 104A may transmit the configuration immediately changing the PSCell to the cell 126A to the UE 102 via SRB1. Extending multi-connectivity coordination can help the newly-added base station coordinate shared UE capabilities.

In other scenarios, the base station 104A can perform a conditional SN Addition procedure to first configure the base station 106B as a C-SN for the UE 102, i.e., conditional SN addition or change (CSAC). At this time, the UE 102 can be in single connectivity (SC) with the base station 104A or in DC with the base station 104A and the base station 106A. If the UE 102 is in DC with the base station 104A and the base station 106A, the MN 104A may determine to perform the conditional SN Addition procedure in response to a request received from the base station 106A or in response to one or more measurement results received from the UE 102 (e.g., extracted from a UE measurement report) or obtained by the MN 104A from measurements on signals (e.g., sounding reference signal (SRS) or uplink demodulation reference signal (DMRS)) received from the UE 102. In contrast to the immediate SN Addition case discussed above, the UE 102 does not immediately attempt to connect to the C-SN 106B. In this scenario, the base station 104A again operates as an MN, but the base station 106B initially operates as a C-SN rather than an SN.

More particularly, when the UE 102 receives a configuration for the C-SN 106B, the UE 102 does not connect to the C-SN 106B until the UE 102 has determined that a certain condition is satisfied (the UE 102 in some cases can consider multiple conditions, but for convenience only the discussion below refers to a single condition). Before the condition is satisfied, multi-connectivity coordination is not necessary; however, it will be helpful as soon as a C-SN becomes connected. When the UE 102 determines that the condition has been satisfied, the UE 102 connects to the C-SN 106B, so that the C-SN 106B begins to operate as the SN 106B for the UE 102. Thus, while the base station 106B operates as a C-SN rather than an SN, the base station 106B is not yet connected to the UE 102, and accordingly is not yet servicing the UE 102. In some implementations, the UE 102 may disconnect from the SN 106A to connect to the C-SN 106B.

In yet other scenarios, the UE 102 is in DC with the MN 104A (via a PCell) and SN 106A (via a PSCell other than cell 126A and not shown in FIG. 1A). The SN 106A can perform conditional PSCell addition or change (CPAC) to configure a candidate PSCell (C-PSCell) 126A for the UE 102. If the UE 102 is configured with a signaling radio bearer (SRB) (e.g., SRB3) to exchange RRC messages with the SN 106A, the SN 106A may transmit a configuration for the C-PSCell 126A to the UE 102 via the SRB, e.g., in response to one or more measurement results, which may be received from the UE 102 via the SRB or via the MN 104A or may be obtained by the SN 106A from measurements on signals received from the UE 102. In case of via the MN 104A, the MN 104A receives the configuration for the C-PSCell 126A. In contrast to the immediate PSCell change case discussed above, the UE 102 does not immediately disconnect from the PSCell and attempt to connect to the C-PSCell 126A.

More particularly, when the UE 102 receives a configuration for the C-PSCell 126A, the UE 102 does not connect to the C-PSCell 126A until the UE 102 has determined that a certain condition is satisfied (the UE 102 in some cases can consider multiple conditions, but for convenience only the discussion below refers to a single condition). When the UE 102 determines that the condition has been satisfied, the UE 102 connects to the C-PSCell 126A, so that the C-PSCell 126A begins to operate as the PSCell 126A for the UE 102. Thus, while the cell 126A operates as a C-PSCell rather than a PSCell, the SN 106A may not yet connect to the UE 102 via the cell 126A. In some implementations, the UE 102 may disconnect from the PSCell to connect to the C-PSCell 126A.

In some scenarios, the condition associated with CSAC or CPAC can be signal strength/quality, which the UE 102 detects on the C-PSCell 126A of the SN 106A or on a C-PSCell 126B of C-SN 106B, exceeding a certain threshold or otherwise corresponding to an acceptable measurement. For example, when the one or more measurement results the UE 102 obtains on the C-PSCell 126A are above a threshold configured by the MN 104A or the SN 106A or above a pre-determined or pre-configured threshold, the UE 102 determines that the condition is satisfied. When the UE 102 determines that the signal strength/quality on the C-PSCell 126A of the SN 106A is sufficiently good (again, measured relative to one or more quantitative thresholds or other quantitative metrics), the UE 102 can perform a random access procedure on the C-PSCell 126A with the SN 106A to connect to the SN 106A. After the UE 102 successfully completes the random access procedure on the C-PSCell 126A, the C-PSCell 126A becomes a PSCell 126A for the UE 102. The SN 106A then can start communicating data (user-plane data or control-plane data) with the UE 102 through the PSCell 126A. In another example, when the one or more measurement results the UE 102 obtains on the C-PSCell 126B are above a threshold configured by the MN 104A or the C-SN 106B or above a pre-determined or pre-configured threshold, the UE 102 determines that the condition is satisfied. When the UE 102 determines that the signal strength/quality on the C-PSCell 126B of the C-SN 106B is sufficiently good (again, measured relative to one or more quantitative thresholds or other quantitative metrics), the UE 102 can perform a random access procedure on the C-PSCell 126B with the C-SN 106B to connect to the C-SN 106B. After the UE 102 successfully completes the random access procedure on the C-PSCell 126B, the C-PSCell 126B becomes a PSCell 126B for the UE 102 and the C-SN 106B becomes an SN 106B. The SN 106B then can start communicating data (user-plane data or control-plane data) with the UE 102 through the PSCell 126B.

In various configurations of the wireless communication system 100, the base station 104A can be implemented as a master eNB (MeNB) or a master gNB (MgNB), and the base station 106A or 106B can be implemented as a secondary gNB (SgNB) or a candidate SgNB (C-SgNB). The UE 102 can communicate with the base station 104A and the base station 106A or 106B (106A/B) via the same RAT such as EUTRA or NR, or different RATs. When the base station 104A is an MeNB and the base station 106A is an SgNB, the UE 102 can be in EUTRA-NR DC (EN-DC) with the MeNB and the SgNB. In this scenario, the MeNB 104A may or may not configure the base station 106B as a C-SgNB to the UE 102. In this scenario, the SgNB 106A may configure cell 126A as a C-PSCell to the UE 102. When the base station 104A is an MeNB and the base station 106A is a C-SgNB for the UE 102, the UE 102 can be in SC with the MeNB. In this scenario, the MeNB 104A may or may not configure the base station 106B as another C-SgNB to the UE 102.

In some cases, an MeNB, an SeNB or a C-SgNB is implemented as an ng-eNB rather than an eNB. When the base station 104A is a Master ng-eNB (Mng-eNB) and the base station 106A is a SgNB, the UE 102 can be in next generation (NG) EUTRA-NR DC (NGEN-DC) with the Mng-eNB and the SgNB. In this scenario, the MeNB 104A may or may not configure the base station 106B as a C-SgNB to the UE 102. In this scenario, the SgNB 106A may configure cell 126A as a C-PSCell to the UE 102. When the base station 104A is an Mng-NB and the base station 106A is a C-SgNB for the UE 102, the UE 102 can be in SC with the Mng-NB. In this scenario, the Mng-eNB 104A may or may not configure the base station 106B as another C-SgNB to the UE 102.

When the base station 104A is an MgNB and the base station 106A/B is an SgNB, the UE 102 may be in NR-NR DC (NR-DC) with the MgNB and the SgNB. In this scenario, the MeNB 104A may or may not configure the base station 106B as a C-SgNB to the UE 102. In this scenario, the SgNB 106A may configure cell 126A as a C-PSCell to the UE 102. When the base station 104A is an MgNB and the base station 106A is a C-SgNB for the UE 102, the UE 102 may be in SC with the MgNB. In this scenario, the MgNB 104A may or may not configure the base station 106B as another C-SgNB to the UE 102.

When the base station 104A is an MgNB and the base station 106A/B is a Secondary ng-eNB (Sng-eNB), the UE 102 may be in NR-EUTRA DC (NE-DC) with the MgNB and the Sng-eNB. In this scenario, the MgNB 104A may or may not configure the base station 106B as a C-Sng-eNB to the UE 102. In this scenario, the Sng-eNB 106A may configure cell 126A as a C-PSCell to the UE 102. When the base station 104A is an MgNB and the base station 106A is a candidate Sng-eNB (C-Sng-eNB) for the UE 102, the UE 102 may be in SC with the MgNB. In this scenario, the MgNB 104A may or may not configure the base station 106B as another C-Sng-eNB to the UE 102.

The base stations 104A, 106A, and 106B can connect to the same core network (CN) 110, which can be an evolved packet core (EPC) 111 or a fifth-generation core (5GC) 160. The base station 104A can be implemented as an eNB supporting an S1 interface for communicating with the EPC 111, an ng-eNB supporting an NG interface for communicating with the 5GC 160, or as a base station that supports the NR radio interface as well as an NG interface for communicating with the 5GC 160. The base station 106A can be implemented as an EN-DC gNB (en-gNB) with an S1 interface to the EPC 111, an en-gNB that does not connect to the EPC 111, a gNB that supports the NR radio interface as well as an NG interface to the 5GC 160, or a ng-eNB that supports an EUTRA radio interface as well as an NG interface to the 5GC 160. To directly exchange messages during the scenarios discussed below, the base stations 104A, 106A, and 106B can support an X2 or Xn interface.

As illustrated in FIG. 1B, the base station 104A supports a cell 124A, the base station 104B supports a cell 124B, the base station 106A supports a cell 126A, and the base station 106B supports a cell 126B. The cells 124A and 126A can partially overlap, as can the cells 124A and 124B, so that the UE 102 can communicate in DC with the base station 104A (operating as an MN) and the base station 106A (operating as an SN) and, upon completing an SN change, with the base station 104A (operating as MN) and the SN 104B. More particularly, when the UE 102 operates in DC with the base station 104A and the base station 106A, the base station 104A operates as an MeNB, an Mng-eNB, or an MgNB, and the base station 106A operates as an SgNB or an Sng-eNB. The cells 124A and 126B can partially overlap. When the UE 102 is in SC with the base station 104A, the base station 104A operates as an MeNB, an Mng-eNB or an MgNB, and the base station 106B operates as a C-SgNB or a C-Sng-eNB. When the UE 102 operates in DC with the base station 104A and the base station 106A, the base station 104A operates as an MeNB, an Mng-eNB or an MgNB, the base station 106A operates as an SgNB or an Sng-eNB, and the base station 106B operates as a C-SgNB or a C-Sng-eNB.

In general, the wireless communication network 100 can include any suitable number of base stations supporting NR cells and/or EUTRA cells. More particularly, the EPC 111 or the 5GC 160 can be connected to any suitable number of base stations supporting NR cells and/or EUTRA cells. Although the examples below refer specifically to specific CN types (EPC, 5GC) and RAT types (5G NR and EUTRA), in general the techniques of this disclosure also can apply to other suitable radio access and/or core network technologies such as sixth generation (6G) radio access and/or 6G core network or 5G NR-6G DC.

FIG. 1C depicts an example distributed implementation of a base station 180, which can be for example the base station 104A, 104B, 106A, or 106B. The base station in this implementation can include a central unit (CU) 172 and one or more distributed units (DUs) 174. The CU 172 is equipped with processing hardware that can include one or more general-purpose processors such as CPUs and non-transitory computer-readable memory storing machine-readable instructions executable on the one or more general-purpose processors, and/or special-purpose processing units. In one example, the CU 172 is equipped with the processing hardware 130. In another example, the CU 172 is equipped with the processing hardware 140. The processing hardware 140 in an example implementation includes an (C-) SN RRC controller configured to manage or control one or more RRC configurations and/or RRC procedures when the base station 106A operates as an SN or a candidate SN (C-SN). The base station 106B can have hardware same as or similar to the base station 106A. The DU 174 is also equipped with processing hardware that can include one or more general-purpose processors such as CPUs and non-transitory computer-readable memory storing machine-readable instructions executable on the one or more general-purpose processors, and/or special-purpose processing units. In some examples, the processing hardware in an example implementation includes a medium access control (MAC) controller configured to manage or control one or more MAC operations or procedures (e.g., a random access procedure) and a radio link control (RLC) controller configured to manage or control one or more RLC operations or procedures when the base station 106A operates as an MN, an SN or a candidate SN (C-SN). The processing hardware may include further a physical layer controller configured to manage or control one or more physical layer operations or procedures.

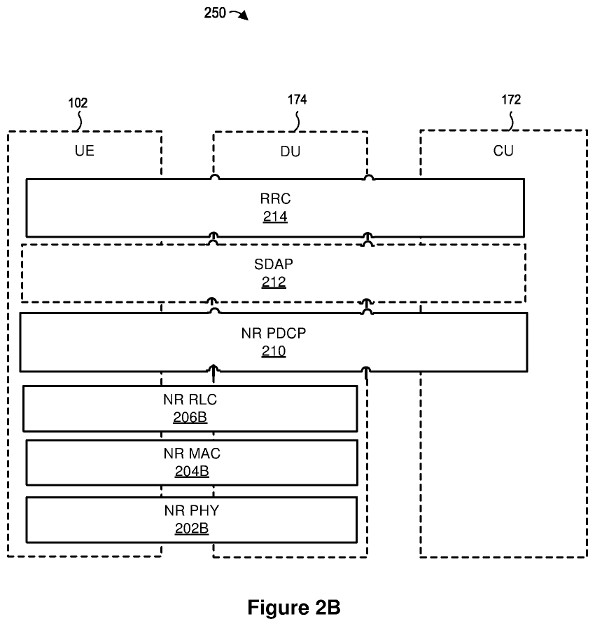

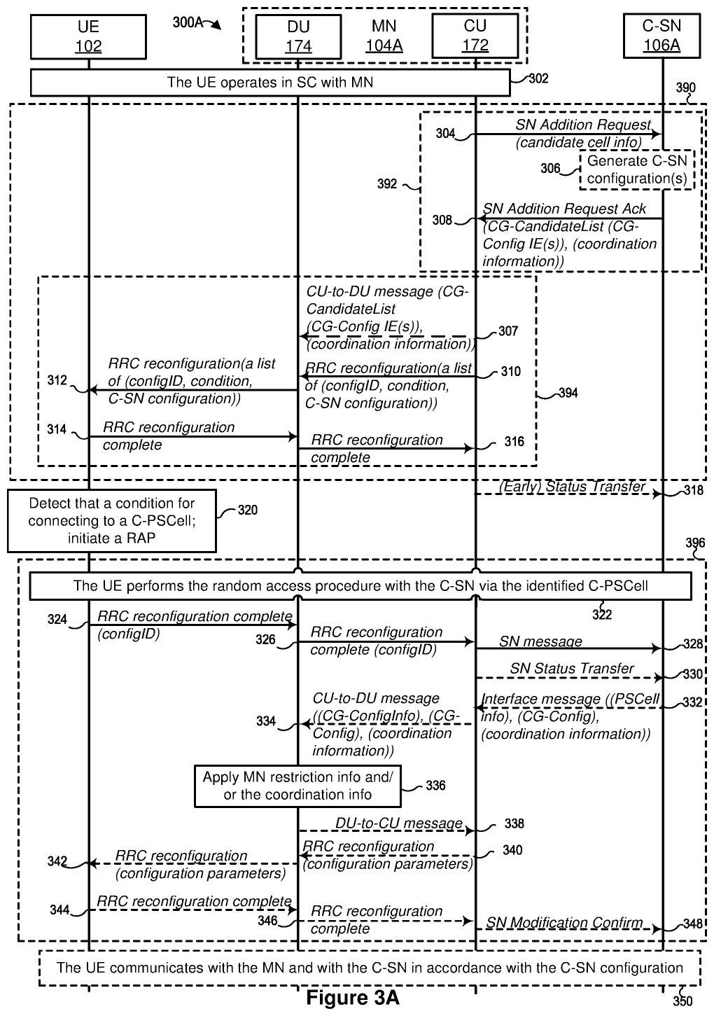

FIG. 2A illustrates, in a simplified manner, an example protocol stack 200 according to which the UE 102 can communicate with an eNB/ng-eNB 230 (e.g., the base station 104A, 104B, 106A, or 106B) or a gNB 232 (e.g., one or more of the base stations 104, 106).

In the example stack 200, a physical layer (PHY) 202A of EUTRA provides transport channels to the EUTRA MAC sublayer 204A, which in turn provides logical channels to the EUTRA RLC sublayer 206A. The EUTRA RLC sublayer 206A in turn provides RLC channels to a EUTRA PDCP sublayer 208 and, in some cases, to an NR PDCP sublayer 210. Similarly, the NR PHY 202B provides transport channels to the NR MAC sublayer 204B, which in turn provides logical channels to the NR RLC sublayer 206B. The NR RLC sublayer 206B in turn provides data transfer services to the NR PDCP sublayer 210. The NR PDCP sublayer 210 in turn can provide data transfer services to Service Data Adaptation Protocol (SDAP) 212 or a radio resource control (RRC) sublayer (not shown in FIG. 2). The UE 102, in some implementations, supports both the EUTRA and the NR stack, as shown in FIG. 2, to support handover between EUTRA and NR base stations and/or to support DC over EUTRA and NR interfaces. Further, as illustrated in FIG. 2, the UE 102 can support layering of NR PDCP 210 over EUTRA RLC 206A, and SDAP sublayer 212 over the NR PDCP sublayer 210.

The EUTRA PDCP sublayer 208 and the NR PDCP sublayer 210 receive packets (e.g., from an Internet Protocol (IP) layer, layered directly or indirectly over the PDCP layer 208 or 210) that can be referred to as service data units (SDUs), and output packets (e.g., to the RLC layer 206A or 206B) that can be referred to as protocol data units (PDUs). Except where the difference between SDUs and PDUs is relevant, this disclosure for simplicity refers to both SDUs and PDUs as “packets.”

On a control plane, the EUTRA PDCP sublayer 208 and the NR PDCP sublayer 210 can provide signaling radio bearers (SRBs) or an RRC sublayer (not shown in FIG. 2) to exchange RRC messages or non-access-stratum (NAS) messages, for example. On a user plane, the EUTRA PDCP sublayer 208 and the NR PDCP sublayer 210 can provide data radio bearers (DRBs) to support data exchange. Data exchanged on the NR PDCP sublayer 210 can be SDAP PDUs, Internet Protocol (IP) packets, or Ethernet packets.

FIG. 2B illustrates, in a simplified manner, an example protocol stack 250 that the UE 102 can use to communicate with a DU (e.g., DU 174) and a CU (e.g., CU 172). The radio protocol stack 200 of FIG. 2A is functionally split as shown by the radio protocol stack 250 in FIG. 2B. The CU at any of the base stations 104 or 106 can hold all the control and upper layer functionalities (e.g., RRC 214, SDAP 212, NR PDCP 210), while the lower layer operations (e.g., NR RLC 206B, NR MAC 204B, and NR PHY 202B) can be delegated to the DU. To support connection to a 5GC, NR PDCP 210 provides SRBs to RRC 214, and NR PDCP 210 provides DRBs to SDAP 212 and SRBs to RRC 214.

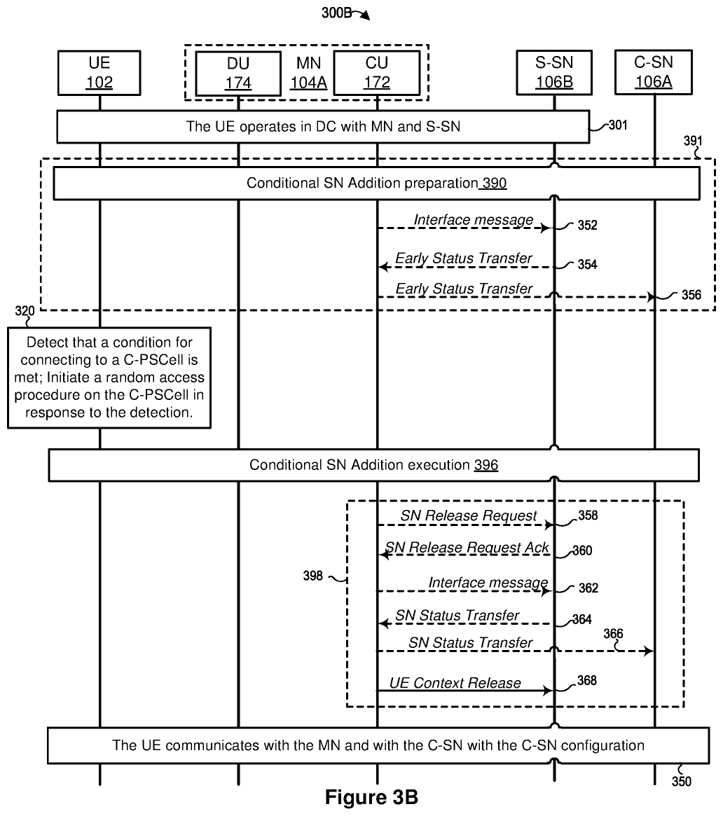

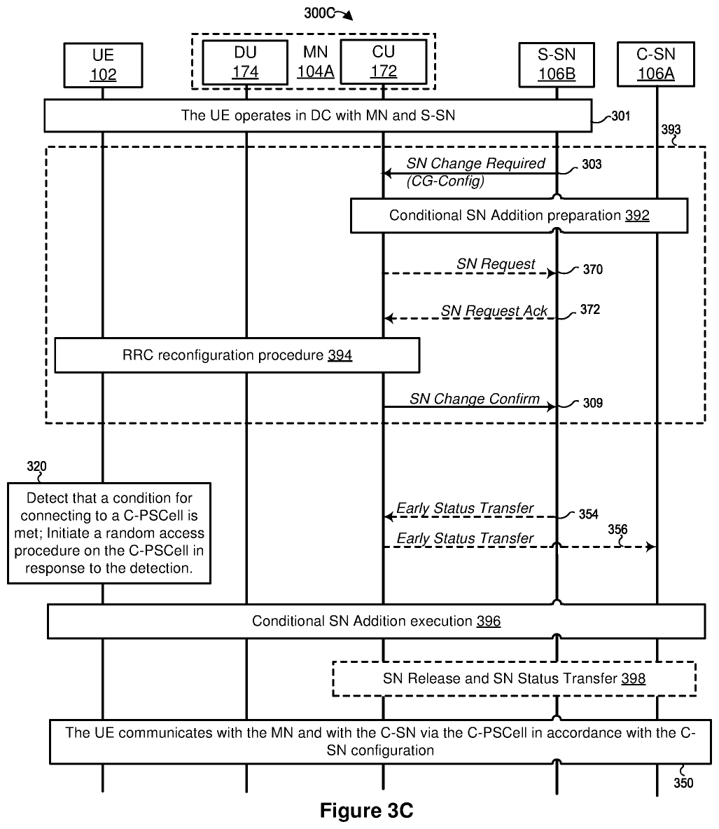

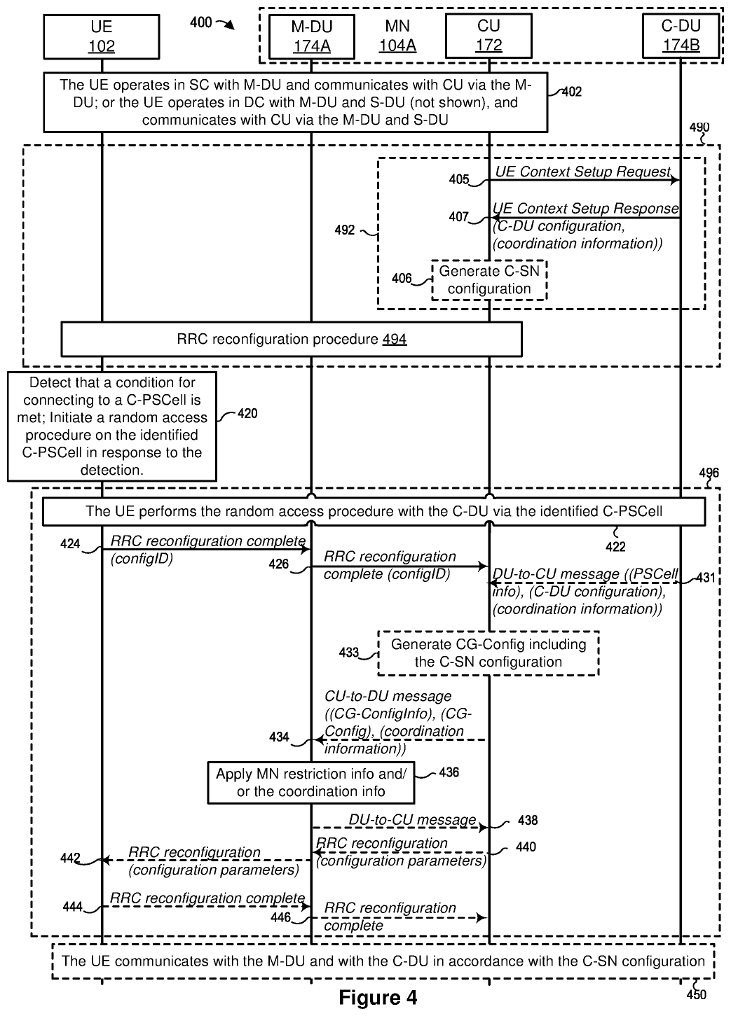

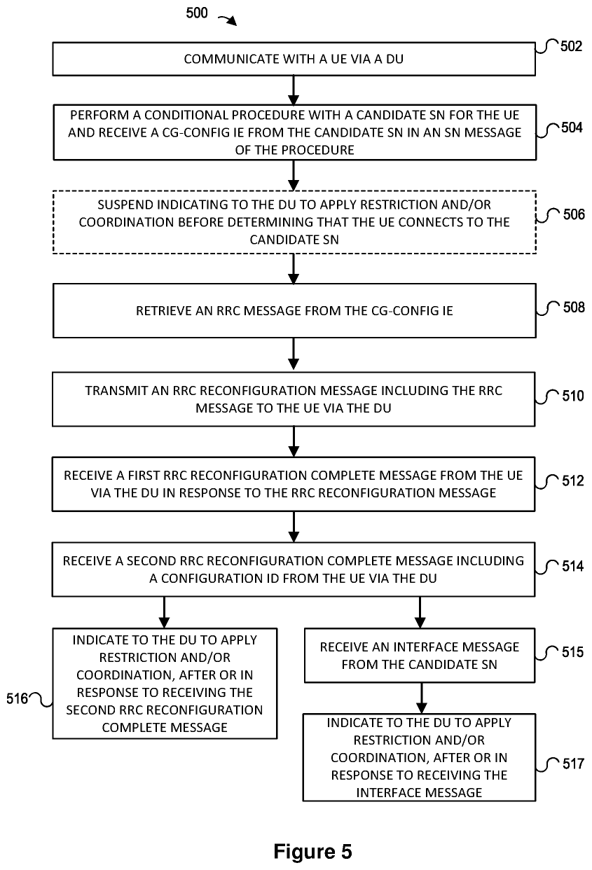

Next, several example scenarios in which a UE and/or a RAN perform the techniques of this disclosure for supporting conditional procedures are discussed with reference to FIGS. 3A-3C and 4. Generally speaking, similar events in FIGS. 3A-3C and 4 are labeled with the same reference numbers, with differences discussed below where appropriate.

Referring first to FIG. 3A, in a scenario 300A, an MN receives and processes one or more SN configurations from a C-SN during a conditional SN addition procedure. In the scenario 300A, the base station 104A operates as an MN, and the base station 106A operates as a C-SN. The MN 104A further includes a CU 172 and one or more DU(s) 174.

Initially, the UE 102 operates 302 in single connectivity (SC) with the MN 104A. While in SC, the UE 102 communicates UL PDUs and/or DL PDUs with the MN 104A (e.g., via a PCell served by a DU 174) in accordance with an MN configuration.

Later in time, the MN 104A (or the CU 172 of the MN 104A) determines to configure the base station 106A as a C-SN for conditional PSCell addition (CPA). The MN 104A can make this determination based on measurement result(s) from the UE 102, for example. In some implementations, the MN 104A can detect or estimate that the UE 102 is moving toward coverage (i.e., one or more cells) of the base station 106A based on uplink signals received from the UE 102 or positioning measurement result(s) received from the UE 102. In response to the determination, the MN 104A (or the CU 172 of the MN 104A) sends 304 an SN Addition Request message including a Conditional PSCell Addition Information Request IE to the C-SN 106A. In some implementations, the Conditional PSCell Addition Information Request IE further includes a CPAC indicator to indicate CPAC-initiation and a Maximum Number of PSCells To Prepare IE/field. The MN 104A can generate candidate cell information including the measurement result(s) of the one or more cells and include the candidate cell information in the SN Addition Request message. Furthermore, the MN 104A (or the CU 172 of the MN 104A) can determine SN restriction information to restrict (values of) configuration parameters that the C-SN 106A can configure for the UE 102. The MN 104A can include the SN restriction information in the SN Addition Request message. The MN 104A (or the CU 172 of the MN 104A) may determine MN restriction information to restrict (values of) configuration parameters that the MN 104A can configure for the UE 102 when determining the SN restriction information. In some implementations, the MN restriction information and/or the SN restriction information include at least one of the fields shown in Table 1 below.

TABLE 1
Example fields in MN and/or SN restriction information

powerCoordination-FR1
Indicates the maximum power that the UE can use in FR1.
powerCoordination-FR2
Indicates the maximum power that the UE can use in frequency range 2 (FR2). This field is only used in NR-DC.
nrdc-PC-mode-FR1
Indicates the uplink power sharing mode that the UE uses in NR-DC FR1 (see TS 38.213 [13], clause 7.6).
nrdc-PC-mode-FR2
Indicates the uplink power sharing mode that the UE uses in NR-DC FR2 (see TS 38.213 [13], clause 7.6).
overheatingAssistanceSCG
Contains the UE's preference on reduced configuration for NR SCG to address overheating. This field is only used in
(NG)EN-DC.
p-maxEUTRA
Indicates the maximum total transmit power to be used by the UE in the E-UTRA cell group (see TS 36.104 [33]). This
field is used in (NG)EN-DC and NE-DC.
p-maxNR-FR1
Indicates the maximum total transmit power to be used by the UE in the NR cell group across all serving cells in frequency
range 1 (FR1) (see TS 38.104 [12]). The field is used in (NG)EN-DC and NE-DC.
p-maxUE-FR1
Indicates the maximum total transmit power to be used by the UE across all serving cells in frequency range 1 (FR1).
p-maxNR-FR1-MCG
Indicates the maximum total transmit power to be used by the UE in the NR cell group across all serving cells in frequency
range 1 (FR1) (see TS 38.104 [12]) the UE can use in NR MCG. This field is only used in NR-DC.
p-maxNR-FR2-SCG
Indicates the maximum total transmit power to be used by the UE in the NR cell group across all serving cells in frequency
range 2 (FR2) (see TS 38.104 [12]) the UE can use in NR SCG.
p-maxUE-FR2
Indicates the maximum total transmit power to be used by the UE across all serving cells in frequency range 2 (FR2).
p-maxNR-FR2-MCG
Indicates the maximum total transmit power to be used by the UE in the NR cell group across all serving cells in frequency
range 2 (FR2) (see TS 38.104 [12]) the UE can use in NR MCG.
pdcch-BlindDetectionSCG
Indicates the maximum value of the reference number of cells for PDCCH blind detection allowed to be configured for the
SCG.
configRestrictInfo
Includes fields for which SgNB is explicitly indicated to observe a configuration restriction.
drx-ConfigMCG
This field contains the complete DRX configuration of the MCG. This field is only used in NR-DC.
drx-InfoMCG
This field contains the DRX long and short cycle configuration of the MCG. This field is used in (NG)EN-DC and NE-DC.
drx-InfoMCG2
This field contains the drx-onDurationTimer configuration of the MCG. This field is only used in (NG)EN-DC.
fr-InfoListMCG
Contains information of FR information of serving cells that include PCell and SCell(s) configured in MCG.
maxToffset
Indicates the maximum Toffset value the SN is allowed to use for scheduling SCG transmissions (see TS 38.213 [13]). This
field is used in NR-DC only when the fields nrdc-PC-mode-FR1-r16 or nrdc-PC-mode-FR2-r16 are set to dynamic. Value
ms0dot5 corresponds to 0.5 ms, value ms0dot75 corresponds to 0.75 ms, value ms1 corresponds to 1 ms and so on.

In some implementations, the MN 104A (or the CU 172 of the MN 104A) can determine the MN restriction information and the SN restriction information in accordance with capabilities of the UE 102. More specifically, the MN 104A determines the MN restriction information and the SN restriction information such that when the UE 102 simultaneously communicates with the MN 104A and C-SN 106A, the communication with the MN 104A and C-SN 106A does not exceed a capability of the UE 102. For example, the MN 104A can determine a maximum uplink power, that MN 104A allows the UE 102 to transmit in communication with the MN 104A, in the MN restriction info, and the MN 104A can determine a maximum uplink power, that C-SN 106A allows the UE 102 to transmit in communication with the C-SN 106A, in the SN restriction information.

In response to receiving 304 the SN Addition Request message, the C-SN 106A determines 306 one or more C-PSCells (C-PSCell(s)) and generates one or more C-SN configurations (C-SN configuration(s)), each C-SN configuration associated with a particular C-PSCell of the C-PSCell(s), for the UE 102. For example, the C-PSCells may be the cell 126A and the cell 126C. In some implementations, the C-SN 106A determines the C-PSCell(s) and the C-SN configuration(s) taking into account the candidate cell information and the SN restriction information. The C-SN 106A generates an inter-node RRC message CG-CandidateList to include a list of CG-CandidateInfo, where each corresponds to a C-PSCell and includes C-PSCell information such as the C-PSCell ID (e.g., SSB frequency/ARFCN-ValueNR and the physical Cell ID) and a CG-Config (e.g., the inter-node RRC message CG-Config defined in 3GPP TS 38.331), to include the C-SN configuration and parameters for the MN to prepare conditional configuration(s). In some implementations, each CG-CandidateInfo IE is included in a specific CG-CandidateToAddModList within the CG-CandidateList. The C-SN 106A transmits 308 an SN Addition Request Acknowledge message including the CG-CandidateList to the MN 104A (or the CU 172 of the MN 104A). In further implementations, the C-SN 106A can generate coordination information and include the coordination information in the SN Addition Request Acknowledge message. In some implementations, the coordination information includes one or more coordination parameters. In some implementations, the C-SN 106A can include the one or more coordination parameters in the respective CG-Config(s) in the CG-CandidateList and/or in the IEs other than the SN to MN Container (e.g., S-NG-RAN node to M-NGRAN node Container or SgNB to MeNB Container) in the SN Addition Request Acknowledge message. For example, the coordination information can include coordination parameters such as a Resource Coordination Information IE (e.g., SgNB Resource Coordination Information IE or MR-DC Resource Coordination Information IE) associated to a particular C-PSCell, one or more power coordination parameters (e.g., powerCoordination-FR1 and/or powerCoordination-FR2), or a discontinuous reception (DRX) configuration (e.g., DRX-Info or DRX-Info2). The coordination information can include coordination information for each of the C-PSCell(s). As another example, the coordination parameters can include one or more coordination parameters as shown in Table 2 below.

TABLE 2
Example Coordination Parameters

configRestrictModReq
Used by SN to request changes to SCG configuration restrictions previously set by MN to ensure UE capabilities are respected.
E.g. can be used to request configuring an NR band combination whose use MN has previously forbidden. SN only includes this
field in SN-initiated procedures.
drx-ConfigSCG
This field contains the complete DRX configuration of the SCG. This field is only used in NR-DC.
drx-InfoSCG
This field contains the DRX long and short cycle configuration of the SCG. This field is used in (NG)EN-DC and NE-DC.
drx-InfoSCG2
This field contains the drx-onDurationTimer configuration of the SCG. This field is only used in (NG)EN-DC.
fr-InfoListSCG
Contains information of FR information of serving cells that include PScell and SCells configured in SCG.
measuredFrequenciesSN
Used by SN to indicate a list of frequencies measured by the UE.
needForGaps
In NE-DC, indicates whether the SN requests gNB to configure measurements gaps.
ph-InfoSCG
Power headroom information in SCG that is needed in the reception of PHR MAC CE of MCG
ph-Supplementary Uplink
Power headroom information for supplementary uplink. In the case of (NG)EN-DC and NR-DC, this field is only present when
two UL carriers are configured for a serving cell and one UL carrier reports type1 PH while the other reports type 3 PH.
ph-Type1or3
Type of power headroom for a certain serving cell in SCG (PSCell and activated SCells). Value type1 refers to type 1 power
headroom, value type3 refers to type 3 power headroom. (See TS 38.321 [3]).
ph-Uplink
Power headroom information for uplink.
pSCellFrequency, pSCellFrequencyEUTRA
Indicates the frequency of PSCell in NR (i.e., pSCellFrequency) or E-UTRA (i.e., pSCellFrequencyEUTRA). In this version of the
specification, pSCellFrequency is not used in NE-DC whereas pSCellFrequencyEUTRA is only used in NE-DC. pSCellFrequency
indicates the absolute FrequencySSB.
reportCGI-RequestNR, reportCGI-RequestEUTRA
Used by SN to indicate to MN about configuring reportCGI procedure. The request may optionally contain information about the
cell for which SN intends to configure reportCGI procedure. In this version of the specification, the reportCGI-RequestNR is used
in (NG)EN-DC and NR-DC whereas reportCGI-RequestEUTRA is used only for NE-DC.
requestedBC-MRDC
Used to request configuring a band combination and corresponding feature sets which are forbidden to use by MN (i.e. outside of
the allowedBC-ListMRDC) to allow re-negotiation of the UE capabilities for SCG configuration.
requestedMaxInterFreqMeasIdSCG
Used to request the maximum number of allowed measurement identities to configure for inter-frequency measurement. This field
is only used in NR-DC.
requestedMaxIntraFreqMeasIdSCG
Used to request the maximum number of allowed measurement identities to configure for intra-frequency measurement on each
serving frequency.
requestedPDCCH-BlindDetectionSCG
Requested value of the reference number of cells for PDCCH blind detection allowed to be configured for the SCG.
requestedP-MaxEUTRA
Requested value for the maximum power for the serving cells the UE can use in E-UTRA SCG. This field is only used in NE-DC.
requestedP-MaxFR1
Requested value for the maximum power for the serving cells on frequency range 1 (FR1) in this secondary cell group (see TS
38.104 [12]) the UE can use in NR SCG.
requestedP-MaxFR2
Requested value for the maximum power for the serving cells on frequency range 2 (FR2) in this secondary cell group the UE can
use in NR SCG. This field is only used in NR-DC.
selectedBandCombination
Indicates the band combination selected by SN in (NG)EN-DC, NE-DC, and NR-DC. The SN should inform the MN with this
field whenever the band combination and/or feature set it selected for the SCG changes (i.e. even if the new selection concerns a
band combination and/or feature set that is allowed by the allowedBC-ListMRDC)
selectedToffset
Indicates the value used by the SN for scheduling SCG transmissions (i.e. T_{proc, ScG}^{max}, see TS 38.213 [13]). This field is used in NR-
DC only when the fields nrdc-PC-mode-FR1-r16 or nrdc-PC-mode-FR2-r16 are set to dynamic. The SN can only indicate a value
that is less than or equal to maxToffset received from MN. This field is used in NR-DC only when MN has included the field
maxToffset in CG-ConfigInfo. Value ms0dot5 corresponds to 0.5 ms, value ms0dot75 corresponds to 0.75 ms, value ms1
corresponds to 1 ms and so on.
servCellInfoListSCG-EUTRA
Indicates the carrier frequency and the transmission bandwidth of the serving cell(s) in the SCG in intra-band NE-DC. The field is
needed when MN and SN operate serving cells in the same band for either contiguous or non-contiguous intra-band band
combination or LTE NR inter-band band combinations where the frequency range of the E-UTRA band is a subset of the
frequency range of the NR band (as specified in Table 5.5B.4.1-1 of TS 38.101-3 [34]) in NE-DC.
servCellInfoListSCG-NR
Indicates the frequency band indicator, carrier center frequency, UE specific channel bandwidth and SCS of the serving cell(s) in
the SCG in intra-band (NG)EN-DC. The field is needed when MN and SN operate serving cells in the same band for either
contiguous or non-contiguous intra-band band combination or LTE NR inter-band band combinations where the frequency range
of the E-UTRA band is a subset of the frequency range of the NR band (as specified in Table 5.5B.4.1-1 of TS 38.101-3 [34]) in
(NG)EN-DC.
transmission Bandwidth-EUTRA
Indicates the transmission bandwidth on an E-UTRA carrier frequency as defined by the parameter Transmission Bandwidth
Configuration “NRB” TS 36.104 [33]. The values rb6, rb15, rb25, rb50, rb75, rb100 indicate 6, 15, 25, 50, 75 and 100 resource
blocks respectively.
ueAssistanceInformationSCG
Includes for each UE assistance feature associated with the SCG, the information last reported by the UE in the NR
UEAssistanceInformation message for the SCG, if any.

In some implementations, the C-SN 106A includes SN restriction information in the SN Addition Request Acknowledge message, which the MN 104A may use to determine the MN restriction information.

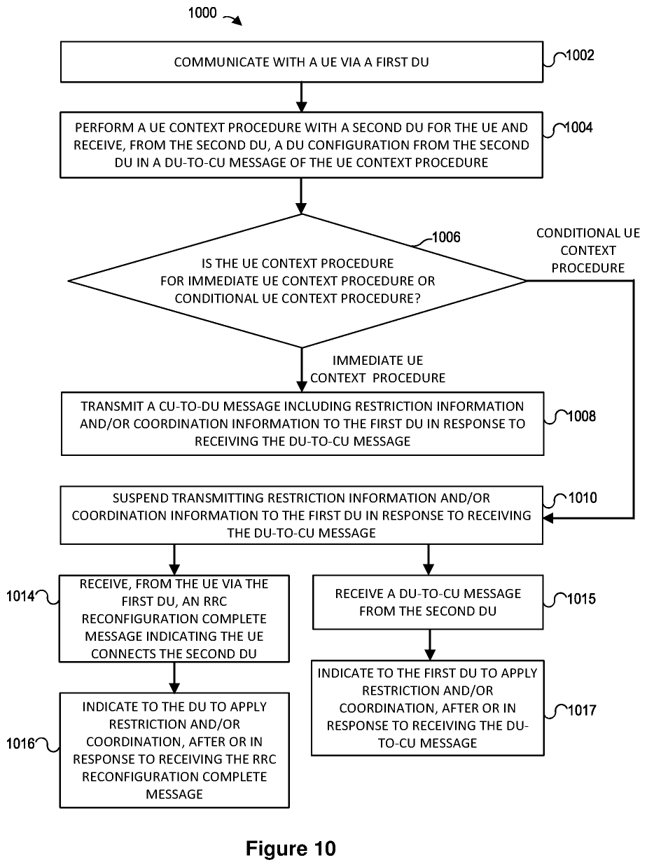

The CU 172, in most scenarios discussed in this disclosure, does not transmit 334 (as will be discussed below) restriction and/or coordination information (i.e., multi-connectivity coordination information) for the candidate cells to the DU 174 prior to determining to which candidate cell the UE 102 has connected. However, in some scenarios, which will be further described with reference to FIG. 11, after receiving 308 the CG-CandidateList including the CG-Config IE(s), and before determining which candidate cell the UE 102 has connected to, the CU 172 transmits 307 a CU-to-DU message including the CG-CandidateList to the DU 174. If the CU 172 received 308 restriction and/or coordination information, the CU 172 may include the restriction and/or coordination information in the CU-to-DU message that the CU 172 transmits 307. The DU 172 can apply the restriction and/or coordination information after or in response to receiving 307 the CU-to-DU message. In some implementations, the CU-to-DU message is a UE Context Modification Request message.

After receiving 308 the CG-Candidate List, for each entry in the CG-CandidateList, the CU 172 of the MN 104A retrieves and correlates the C-PSCell ID and the C-SN configuration and can use the C-PSCell ID and/or the C-SN ID (e.g., Global en-gNB ID, or Global NG-RAN Node ID) for differentiating and managing the C-SN configuration to prepare a conditional configuration. The CU 172 can assign a particular configuration ID (e.g., condReconfigId or CondReconfigurationId) to each of the C-SN configuration(s). The CU 172 can generate the trigger condition configurations (e.g., condExecutionCond or triggerCondition) for each of the C-SN configuration(s). Each of the trigger condition configurations can link to one or more measurement configurations that triggers the UE 102 to connect to the C-SN 106A via a particular C-PSCell configured in a particular C-SN configuration. In some implementations, the CU 172 can generate a conditional (re) configuration IE (e.g., ConditionalReconfiguration) to include a list of the C-SN configuration(s) with the corresponding configuration ID and the trigger condition configurations. The conditional (re) configuration IE is included in an RRC reconfiguration message (e.g., RRCConnectionReconfiguration message or RRCReconfiguration message). The CU 172 can transmit 310 the RRC reconfiguration message to the DU 174 in a CU-to-DU message (e.g., DL RRC Message Transfer or UE Context Modification Request message). The DU 174 transmits 312 the RRC reconfiguration message including the conditional (re) configuration fields/IEs to the UE 102. The UE 102 applies the RRC reconfiguration and replies 314 an RRC reconfiguration complete message (e.g., RRCConnectionReconfiguration Complete messages or RRCReconfiguration Complete message) to the DU 174. The DU 174 then transmits 315 the RRC reconfiguration complete message in a DU-to-CU message (e.g., UL RRC Message Transfer message or UE Context Modification Response message) to the CU 172. The events 304, 306, 307, 308, 310, 312, 314, and 316 can be collectively referred as an MN-initiated Conditional SN Addition preparation 390. The events 304, 306, 308 can further be collectively referred as a Conditional SN Addition preparation 392, while the events 310, 312, 314, and 316 can be collectively referred as an RRC reconfiguration procedure 394. After receiving 316 the RRC reconfiguration complete message or an acknowledgement (e.g., RLC acknowledgement or hybrid automatic repeat request (HARQ) acknowledgement) for a PDU (e.g., RLC PDU or MAC PDU) including the RRC reconfiguration message, the CU 172 of the MN 104A can transmit 318 an Early Status Transfer message to the C-SN 106A to transfer a COUNT value of the first downlink SDU that the MN 104A forwards to the C-SN 106A or a COUNT value for discarding of already forwarded downlink SDUs for each of DRB(s) of the UE 102. The Early Status Transfer message may be an Early Sequence Number (SN) Status Transfer message, where “SN” in this context refers to sequence number rather than secondary node. The MN 104A can send 318 the Early Status Transfer message without receiving an interface message indicating the UE 102 connects to the C-SN 106A.

Later in time, if the UE 102 detects 320 that a condition for connecting to a C-PSCell is satisfied, the UE 102 connects to the C-PSCell. That is, the condition (or “triggering condition”) triggers the UE 102 to connect to the C-PSCell or to execute the C-SN configuration concerning the C-PSCell. In response to the detection, the UE 102 initiates a random access procedure on the C-PSCell. In response to the initiation, the UE 102 performs 322 the random access procedure with the C-SN 106A via the identified C-PSCell. In response to the detection or initiation 320, the UE 102 sends 324 an RRC reconfiguration complete message to the MN 104A via the DU 174. The DU 174 transmits 326 the RRC reconfiguration complete message in a DU-to-CU message (e.g., UL RRC Message Transfer message) to the CU 172. The UE 102 can transmit 324 the RRC reconfiguration complete message before, during or after the random access procedure.

In some implementations, the UE 102 may indicate, in the RRC reconfiguration complete message, that the UE 102 has executed one of the C-SN configuration(s) by including a configuration ID corresponding to the particular C-SN configuration. The CU 172 of the MN 104A can use the configuration ID to identify or determine the ID of the C-PSCell (e.g., the PCI and/or the CGI of the C-PSCell) and/or the C-SN if the MN 104A performs multiple CPA procedures with different C-SNs.

In response to or after receiving 326 the RRC reconfiguration complete message, the CU 172 of the MN 104A can transmit 328 an SN message to the C-SN 106A. In some implementations, the SN message can be an SgNB Reconfiguration Complete or S-Node Reconfiguration Complete message. In other implementations, the SN message can be an RRC Transfer message. In yet other implementations, the SN message can be a new interface message (e.g., XnAP or X2AP message) defined in 3GPP 38.423 or 36.423 release 17 or future specifications. In some implementations, the UE 102 can include an SN RRC message (e.g., RRCConnectionReconfigurationComplete or RRCReconfigurationComplete message) in the RRC reconfiguration complete message that the UE 102 transmits at event 324. In such cases, the MN 104A can include the SN RRC message in the SN message.

In some implementations, the random access procedure can be a four-step random access procedure or a two-step random access procedure. In other implementations, the random access procedure can be a contention-based random access procedure or a contention-free random access procedure. For example, the UE 102 may include an RRC reconfiguration complete message in a message 3 of the four-step random access procedure or in a message A of the two-step random access procedure.

After the C-SN 106A successfully completes the random access procedure with the UE 102, the C-SN 106A can send 332 an interface message (e.g., SN Modification Required message, an NG-RAN node Configuration Update message, a E-UTRA-NR Cell Resource Coordination Request message, or a success indication message), which may include the PSCell information of the PSCell (e.g., cell 126A), and/or the corresponding CG-Config IE for the executed C-SN configuration, and/or coordination information (e.g., SgNB Resource Coordination Information IE or MR-DC Resource Coordination Information IE) for Physical Resource Block (PRB) coordination to the CU 172 of the MN 104A. The PSCell information can include a cell global identity (CGI), a physical cell identity (PCI), and/or an absolute radio frequency channel number (ARFCN) identifying a DL carrier frequency of the PSCell 126A. In some implementations, the C-SN 106A can send 332 the interface message in response to or after receiving the SN message or performing 322 the random access procedure. In some implementations, the interface message further includes the SN restriction information. The MN 104A (the CU 172 and/or the DU 174) may use the SN restriction information to determine the MN restriction information.

In some implementations, in response to or after receiving 326 the RRC reconfigurations, the CU 172 of the MN 104A can also use the configuration ID to determine (e.g., identify or select) the CG-Config corresponding to the C-PSCell out of the CG-CandidateList received in event 308. In such case, the C-SN 106A might not include the CG-Config in the interface message at event 332 or the C-SN 106A might not transmit 332 the interface message (e.g., if the C-SN 106A previously transmitted the coordination information to the MN 104A at event 308).

The CU 172 of the MN 104A may, after or in response to the event 326 or event 332 (i.e., after identifying, either based on event 326 or event 332, the C-PSCell to which the UE has connected), transmit 334 a CU-to-DU message (e.g., UE Context Modification Request message), which may include a CG-ConfigInfo (e.g., the inter-node RRC message CG-ConfigInfo defined in 3GPP TS 38.331), and/or the CG-Config corresponding to the C-PSCell to which the UE has connected, and/or the coordination information to the DU 174 of the MN 104A. The CU 172 can transmit the coordination information corresponding to the C-PSCell to which the UE has connected. The CG-ConfigInfo may include the MN restriction information. After receiving 334 the CU-to-DU message, the DU 174 of the MN 104A applies 336 the MN restriction information and/or the coordination information. If the DU 174 previously received 307 the restriction and/or coordination information from the CU 172, then the DU 174 can determine to which candidate cell the UE 102 connected based on the CU-to-DU message that the DU 174 receives 334. The DU 174 can then discard (i.e., release or stop applying) the restriction and/or coordination information for the other candidate cells not connected to the UE 102, as will be discussed with reference to FIG. 11.

In some implementations, applying the MN restriction information and/or the coordination information means that, for example, the DU 174 configures an uplink power value within the maximum power allowable for the MCG (e.g., p-maxNR-FR1-MCG) considering also the requested maximum power of the SCG (e.g., requested-MaxFRI) and/or the UE capability (e.g., p-maxUE-FR1). As another example, the DU 174 may configure the PRBs for MCG not to overlap with the PRBs used or configured by the SCG (e.g., as indicated in the UL Coordination Information or DL Coordination Information field/IE). The DU 174 may transmit 338 a DU-to-CU message (e.g., UE Context Modification Response message) to the CU 172. In response to applying 336 the MN restriction information and/or the coordination information, the MN 104A may decide to transmit an RRC reconfiguration message including the configuration parameters to the UE 102. Therefore, the CU 172 transmits 340 the RRC reconfiguration message in a CU-to-DU message (e.g., DL RRC Message Transfer or UE Context Modification Request message) to the DU 174 and the DU 174 transmits 342 the RRC reconfiguration message to the UE 102. In some implementations, the configuration parameters 342 may reconfigure or release (values) of configuration parameters that the UE 102 uses to communicate with the MN 104A. In other implementations, the configuration parameters 342 may be new configuration parameters to configure the UE 102 to communicate with the MN 104A. In response to the RRC reconfiguration message 342, the UE 102 can send 344 an RRC reconfiguration complete message to the DU 174 and the DU 174 transmits 346 the RRC reconfiguration complete message to the CU 172 in a DU-to-CU message (e.g., UL RRC Message Transfer or UE Context Modification Request message). The CU 102 of the MN 104A may in response transmit 348 an SN Modification Confirm message (e.g., SgNB Modification Confirm or S-Node Modification Confirm message). The events 322, 324, 326, 328, 330, 332, 334, 336, 338, 340, 342, 344, 346, 348 can be collectively referred as a Conditional SN Addition execution procedure 396.

In response to or after receiving 326 the RRC reconfiguration complete message or 332 the interface message, the MN 104A can send 330 an SN Status Transfer message to transfer uplink PDCP SN and HFN receiver status and/or downlink PDCP SN and HFN transmitter status for each of DRB(s) of the UE 102. In contrast to event 318, the MN 104A sends 330 a (non-early) SN Status Transfer message.

After the UE 102 successfully completes 322 the random access procedure, the UE 102 communicates 350 with the MN and with the C-SN via the C-PSCell in accordance with the C-SN configuration.

With continued reference to FIG. 3A, the C-SN configuration in some implementations can be a complete and self-contained configuration (i.e., a full configuration). The C-SN configuration may include a full configuration indication (an information element (IE) or a field) that identifies the C-SN configuration as a full configuration. The UE 102 in this case can use the C-SN configuration to communicate with the SN 106A without relying on an SN configuration. On the other hand, the C-SN configuration in other cases can include a “delta” configuration, or one or more configurations that augment a previously received SN configuration. In these cases, the UE 102 can use the delta C-SN configuration together with the SN configuration to communicate with the C-SN 106A.

The C-SN configuration can include multiple configuration parameters for the UE 102 to apply when communicating with the C-SN 106A via a C-PSCell. The multiple configuration parameters may configure the C-PSCell and zero, one, or more candidate secondary cells (C-SCells) of the C-SN 106A to the UE 102. The multiple configuration parameters may configure radio resources for the UE 102 to communicate with the C-SN 106A via the C-PSCell and zero, one, or more C-SCells of the C-SN 106A. The multiple configuration parameters may configure zero, one, or more radio bearers. The one or more radio bearers can include an SRB and/or one or more DRBs.

In some implementations, the C-SN configuration can include a group configuration (CellGroupConfig) IE that configures the C-PSCell and zero, one, or more C-SCells of the C-SN 106A. In one implementation, the C-SN configuration includes a radio bearer configuration. In another implementation, the C-SN configuration does not include a radio bearer configuration. For example, the radio bearer configuration can be a RadioBearerConfig IE, DRB-ToAddModList IE or SRB-ToAddModList IE, DRB-ToAddMod IE or SRB-ToAddMod IE. In various implementations, the C-SN configuration can be an RRCReconfiguration message, RRCReconfiguration-IEs, or the CellGroupConfig IE conforming to 3GPP TS 38.331. The full configuration indication may be a field or an IE conforming to 3GPP TS 38.331. In other implementations, the C-SN configuration can include an SCG-ConfigPartSCG-r12 IE that configures the C-PSCell and zero, one, or more C-SCells of the C-SN 106A. In some implementations, the C-SN configuration is an RRCConnectionReconfiguration message, RRCConnectionReconfiguration-IEs, or the ConfigPartSCG-r12 IE conforming to 3GPP TS 36.331. The full configuration indication may be a field or an IE conforming to 3GPP TS 36.331.

Still referring to FIG. 3A, the base station 106A (i.e., the C-SN) in some cases can also include the CU 172 and one or more DUs 174 as illustrated in FIG. 1C. For each of the C-SN configuration(s), the one or more DUs 174 can generate the C-SN configuration. Alternatively, for each of the C-SN configuration(s), the one or more DUs 174 can generate a portion of the C-SN configuration and the CU 172 may generate the remainder of the C-SN configuration. For example, the UE 102 performs 322 the random access procedure with the first DU 174A operating the (C-) PSCell and the first DU 174A may identify the UE 102 in the random access procedure. In this case, the UE 102 communicates 350 with the SN 106A via the first DU 174A.

The first DU 174A of the C-SN 106A operating the C-PSCell may generate the C-SN configuration configuring the C-PSCell or a portion of the C-SN configuration and send the C-SN configuration or the portion of the C-SN configuration to the CU 172. In cases involving generating a portion of the C-SN configuration, the CU 172 generates the remainder of the C-SN configuration. In some scenarios or implementations, the first DU 174A generates each of the other C-SN configuration(s). Alternatively, for each of the other C-SN configuration(s), the first DU 174A generates a portion of the C-SN configuration and the CU 172 generates the remainder of the C-SN configuration. In other scenarios or implementations, the first DU 174A generates at last one first C-SN configuration in the C-SN configuration(s). Alternatively, for each of the at least one first C-SN configuration, the first DU 174A generates a portion of the C-SN configuration and the CU 172 generates the remainder of the C-SN configuration. A second DU 174B of the C-SN 106A generates at least one second C-SN configuration in the C-SN configuration(s). Alternatively, for each of the at least one second C-SN configuration, the second DU 174B generates a portion of the C-SN configuration and the CU 172 generates the remainder of the C-SN configuration.

Referring next to FIG. 3B, a scenario 300B is similar to the scenario 300A. However, in the scenario 300B, the MN 104A initially operates in DC with a source SN (S-SN) 106B to connect to the UE 102 and later decides to perform a conditional SN change procedure. The interactions between MN 104A and C-SN 106A are similar to those described in FIG. 3A. The differences between FIGS. 3B and 3A are further described below.

The UE 102 is initially in dual connectivity 301 with the MN 104A and the S-SN 106B and communicates with the S-SN 106B via a PSCell in accordance with the S-SN configuration. Later in time, the MN 104A, C-SN 106A, and UE 102 performs the Conditional SN Addition preparation procedure 390. In cases where early data forwarding is needed, the MN 104A may transmit 352 an Interface message (e.g., Xn-U Address Indication or Data Address Indication message) to the S-SN 106B. The S-SN 106B then transmits 354 an Early Status Transfer message to the MN 104A and the MN 104A transmits 356 an Early Status Transfer message to the C-SN 106A. Events 390, 352, 354, and 356 can be collectively referred as an event 391 for MN-initiated Conditional SN Change preparation.

Similar to FIG. 3A, the UE 102 later detects 320 that a condition for connecting to the C-PSCell is met and performs a random access procedure on the C-PSCell in response to the detection with the C-SN 106A. The UE 102, MN 104A, and C-SN 106A performs the Conditional SN Addition execution 396. The MN 104A transmits 358 an SN Release Request message (e.g., SgNB Release Request or S-Node Release Request message) to the S-SN 106B. The S-SN 106B in response transmits 360 an SN Release Request Acknowledge message (e.g., SgNB Release Request Acknowledge or S-Node Release Request Acknowledge message). In cases where data forwarding is needed, the MN 104A may transmit 362 an Interface message (e.g., Xn-U Address Indication or Data Address Indication message) to the S-SN 106B to signal the forwarding address information for the user plane data. The S-SN 106B then may transmit 364 an SN Status Transfer message to the MN 104A and the MN 104A then may transmit 366 an SN Status Transfer message to the C-SN 106A. The MN 104A transmits 368 a UE Context Release message to the S-SN 106B. The events 358, 360, 362, 364, 366, and 368 can be collectively referred as an SN Release and SN Status Transfer procedure 398.

After the UE 102 successfully completes the 322 the random access procedure, the UE 102 communicates 350 with the MN and with the C-SN via the C-PSCell in accordance with the C-SN configuration.

Referring next to FIG. 3C, the scenario 300C depicts an SN-initiated conditional SN Change scenario where the MN 104A initially connects with an S-SN 106B and later is triggered by S-SN 106B to perform a conditional change procedure with the C-SN 106A. The interactions between MN 104A and C-SN 106A are similar to those described in FIG. 3A or 3B. The differences between FIG. 3C and FIGS. 3A and 3B are described below.

The S-SN 106B at some time point decides to initiate a conditional SN change procedure and transmits 303 an SN Change Required message (e.g., SgNB Change Required or S-Node Change Required message defined in the 3GPP TS 36.423 and 38.423, respectively) including a candidate/target SN ID (e.g., Global en-gNB ID, or Global NG-RAN Node ID, which, for example, refers to the C-SN 106A), and the CG-Config, which further includes the proposed candidate cell information (e.g., physical cell ID and/or related cell measurement results) and the trigger condition(s) (e.g., condExecutionCond-SCG IE, which may include measurement ID(s) referring to a configured S-SN measurement) for the corresponding candidate cell(s) to the MN 104A. The MN 104A and the C-SN 106A perform the Conditional SN Addition preparation procedure 392 with the proposed candidate cell information from the S-SN 106B. The MN 104A may transmit 370 an SN Request message (e.g., SgNB Modification Request or S-Node Modification Request message) to provide the candidate PSCell(s) accepted by the C-SN 106A to the S-SN 106B. The S-SN 106B in response may transmit 372 an SN Request Acknowledge message (e.g., SgNB Modification Request Acknowledge or S-Node Modification Request Acknowledge message) to provide the updated measurement configuration and/or trigger condition(s). The MN 104A performs 394 an RRC reconfiguration procedure with the UE 102. The MN 104A transmits 309 an SN Change Confirm message (e.g., SgNB Change Confirm or S-Node Change Confirm message) to the S-SN 106B. The events 303, 392, 370, 372, 394, and 309 can be collectively referred as the SN-initiated Conditional SN Change preparation procedure 393.

If the UE 102 later detects 320 that a condition for connecting to a C-PSCell is met, similarly the UE 102 performs the random access procedure with the C-SN 106A via the C-PSCell, the Conditional SN Addition Execution procedure 396, and the SN Release and SN Status Transfer procedure 398. However, different from the scenario 300B, the MN 104A might not transmit 344 the SN Release Request message and the S-SN 106B might therefore not transmit 346 the SN Release Request Acknowledge message.

Next, FIG. 4 illustrates a scenario 400 where the UE 102 is connected to a single base station (e.g., the MN 104A) and the base station later acts both as an MN and as an SN and configures both the MCG and SCG. The scenario 400 is similar to scenarios 300A-300C and the same actions and events are labeled with the same numbers. The differences between FIG. 4 and FIGS. 3A-3C are further described below.

The UE 102 initially operates 402 in SC with an M-DU 174A and communicates with the CU 172 via the M-DU 174A or operates 402 in DC with the M-DU 174A and an S-DU (for example, DU 174C, not shown in this figure) and communicates with the CU 172 via the M-DU 174A and the S-DU.

The CU 172 later transmits 405 a UE Context Setup Request message including a conditional indication to the C-DU 174B. In response, the C-DU 174B transmits 407 a UE Context Setup Response message including a C-DU configuration and/or a corresponding coordination information to the CU 172. The CU 172 may generate 406 a C-SN configuration based on the C-DU configuration. The CU 172, M-DU 174A, and UE 102 perform 494 an RRC reconfiguration procedure analogous to procedure 394. Events 405, 407, and 406 can be collectively referred as an event 492. Events 492 and 494 further can be collectively referred as a procedure 490 for Conditional SN Addition preparation in a single base station.

The UE 102 may later detect 420 that a condition for connecting to a C-PSCell is met and initiate a random access procedure on the identified C-PSCell in response to the detection. In response to the initiation, the UE 102 performs 422 the random access procedure with the C-DU 174B via the identified C-PSCell. In response to the detection or initiation 420, the UE 102 sends 424 an RRC reconfiguration complete message including the configuration ID corresponding to the C-PSCell to the CU 172 via the M-DU 174A. The M-DU 174A transmits 426 the RRC reconfiguration complete message in a DU-to-CU message (e.g., UL RRC Message Transfer message) to the CU 172. The UE 102 can transmit 424 the RRC reconfiguration complete message before, during or after the random access procedure. The C-DU 174B may transmit 431 a DU-to-CU message (e.g., Access Success, or UE Context Modification Required message) including a PSCell information (e.g., CGI) and/or the C-DU configuration and/or the corresponding coordination information. The CU 172 may generate 433 a CG-Config including the C-SN configuration and/or other coordination parameters. The CU 172 may also generate a CG-ConfigInfo including the MN restriction information. The CU 172 may transmit 434 a CU-to-DU message (e.g., UE Context Modification Request message), which may include a CG-ConfigInfo, and/or a CG-Config, and/or the coordination information to the M-DU 174A, similar to the event 334. The M-DU 174A applies 436 the MN restriction information and/or the coordination information. The M-DU 174A may transmit 438 a DU-to-CU message (e.g., UE Context Modification Response message) to the CU 172. In response to applying 436 the MN restriction information and/or the coordination information, the MN 104A may decide to transmit an RRC reconfiguration message including the configuration parameters to the UE 102. Therefore, the CU 172 transmits 440 the RRC reconfiguration message in a CU-to-DU message (e.g., DL RRC Message Transfer or UE Context Modification Request message) to the M-DU 174A and the M-DU 174A transmits 342 the RRC reconfiguration message to the UE 102. In some implementations, the configuration parameters 442 may reconfigure or release (values) of configuration parameters that the UE 102 uses to communicate with the MN 104A. In other implementations, the configuration parameters 442 may be new configuration parameters to configure the UE 102 to communicate with the MN 104A. In response to the RRC reconfiguration message 442, the UE 102 can send 444 an RRC reconfiguration complete message to the M-DU 174A and the M-DU 174A transmits 446 the RRC reconfiguration complete message to the CU 172 in a DU-to-CU message (e.g., UL RRC Message Transfer or UE Context Modification Request message). The CU 172 of the MN 104A may in response transmit 348 an SN Modification Confirm message (e.g., SgNB Modification Confirm or S-Node Modification Confirm message). The events 422, 424, 426, 431, 433, 434, 436, 438, 440, 442, 444, 446, 450 can be collectively referred as a Conditional SN Addition execution procedure in a single base station 496. The UE communicates 450 with the M-DU 174A and with the C-DU 174B in accordance with the C-SN configuration.

In some implementations, if the above events concern a (MN- or SN-initiated) SN Change, the CU 172 may transmit a UE Context Release Command message to the S-DU after the successful execution of the C-SN configuration.

In some implementations, the CU 172 and a single DU 174 serve both the MCG and SCG in different cells. In such case, the events 405 and 407 can be a UE Context Modification Request and a UE Context Modification Response message, respectively, between the CU 172 and the M-DU 174A, for example. Similarly, the events 431 and 434 may also take place between the M-DU 174A and the CU 172, for example.

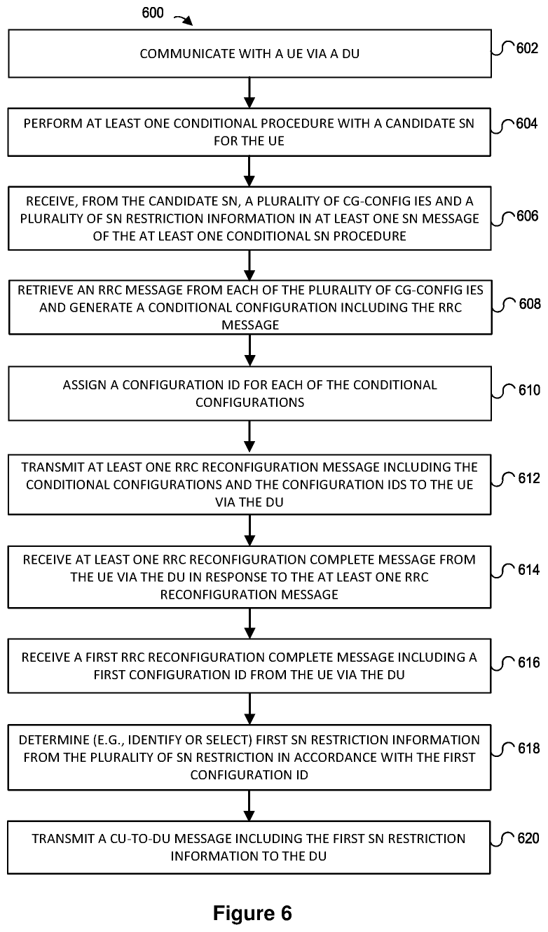

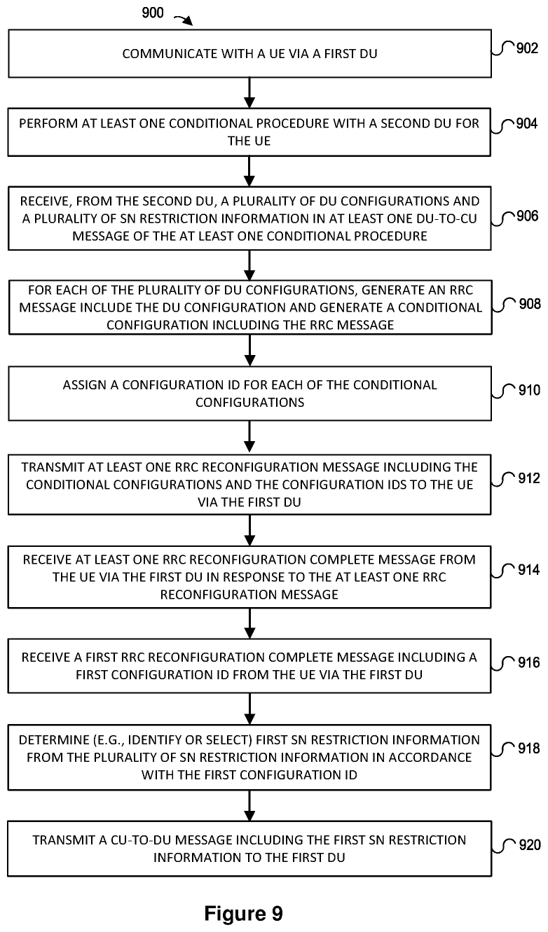

FIGS. 5-11 are flow diagrams depicting example methods that a base station CU (e.g., the CU 172 of the base station 104A or 106B) can implement to support conditional procedures in accordance with the techniques of this disclosure. As indicated at various points throughout this disclosure, the example methods depicted in FIGS. 5-11 may be implemented during the scenarios 300A-300C and 400 described above. In particular, FIGS. 5-7 illustrate conditional procedures that may be performed by two base stations (i.e., inter-base station conditional procedures, such as in scenarios 300A-300C), and FIGS. 8-10 illustrate similar conditional procedures that may be performed by a single base station (i.e., intra-base station conditional procedures, such as in scenario 400).

Referring to FIG. 5, a method 500 where an MN-CU (e.g., the CU 172 of the MN 104A), performs a conditional SN procedure with a candidate SN (e.g., the C-SN 106A) for a UE (e.g., the UE 102) is described.

During the method 500, the CU at block 502 communicates with a UE via a DU. The CU at block 504 performs a conditional procedure (e.g., CPA or CPC) with a candidate SN for the UE and receive a CG-Config IE from the candidate SN in an SN message of the procedure (e.g., event 308). At block 506, the CU may suspend indicating to the DU to apply restriction and/or coordination information before determining that the UE connects to the candidate SN. This is in contrast to an immediate SN procedure, in which the CU may transmit restriction and/or coordination information to the DU prior to determining that the UE connects to the C-SN. The CU at block 508 retrieves an RRC message from the CG-Config IE. At block 510, the CU transmits an RRC reconfiguration message including the RRC message to the UE via the DU (e.g., events 310 and 312). The CU at block 512 receives a first RRC Reconfiguration complete message from the UE via the DU in response to the RRC reconfiguration message (e.g., events 314 and 316). The CU at block 514 receives a second RRC Reconfiguration complete message including a configuration ID from the UE via the DU (e.g., events 324 and 326). The flow can then proceed to block 516 where the CU indicates to the DU to apply restriction and/or coordination information, after or in response to receiving the second RRC reconfiguration complete message (e.g., event 334). Alternatively, after block 514, the flow can proceed to block 515 where the CU receives an interface message from the candidate SN (e.g., event 332). The flow can then proceed to block 517 where the CU indicates to the DU to apply restriction and/or coordination information, after or in response to receiving the interface message (e.g., event 334). The flow may proceed to block 516 rather than 515 if the CU is able to determine, based on the configuration ID received at block 514, the CG-Config corresponding to the C-PSCell to which the UE has connected. If the CU is not able to make such a determination, the flow may proceed to blocks 515 and 517, where the interface message indicates the CG-Config corresponding to the C-PSCell.

In some implementations, the CU can transmit to the DU a first CU-to-DU message to indicate to the DU to apply restriction and/or coordination, after or in response to receiving the second RRC reconfiguration complete message. After or in response to receiving the indication or the first CU-to-DU message from the CU, the DU applies restriction and/or coordination information to communicate with the UE in accordance with restriction information and/or coordination information.

In some implementations, the CU can include the restriction information and/or coordination information in the first CU-to-DU message. Alternatively, the CU can transmit to the DU at least one second CU-to-DU message including the restriction information and/or coordination information, before transmitting the first CU-to-DU message. Yet alternatively, the DU can be preconfigured with the restriction information and/or coordination information.

In some implementations, the restriction information includes MN restriction information and/or SN restriction information. In some implementations, the CU can include the MN restriction information in a CG-ConfigInfo IE and includes the CG-ConfigInfo IE in the first CU-to-DU message or the second CU-to-DU message.

In some implementations, the CU receives, from the candidate SN, a CG-Config IE and/or the coordination information in an SN message of the conditional procedure. The CG-Config IE includes the SN restriction information. The CU can include the CG-Config IE in the CU-to-DU message to transmit the SN restriction information to the DU.

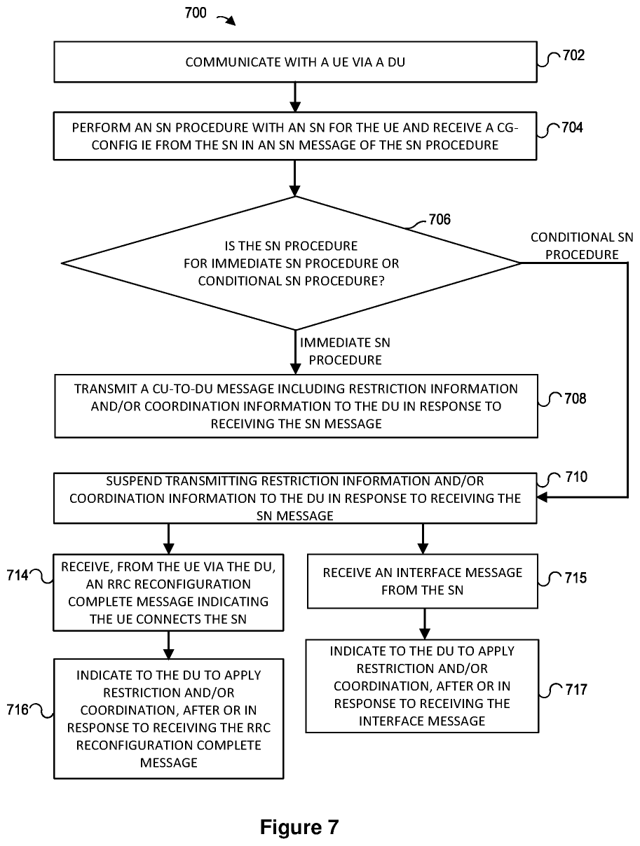

Turning to FIG. 6, a method 600 where an MN-CU (e.g., the CU 172 of the MN 104A), performs a conditional SN procedure with a candidate SN (e.g., the C-SN 106A) for a UE (e.g., the UE 102) is described. The method 600 is similar to the method 500, except that the MN-CU receives a plurality of CG-Config IEs and a plurality of SN restriction information.

The method 600 starts at block 602 where the CU communicates with a UE via a DU. The CU at block 604 performs at least one conditional procedure (e.g., CPA or CPC) with a candidate SN for the UE (e.g., event 304). The CU at block 606 receives, from the candidate SN, a plurality of CG-Config IEs and a plurality of SN restriction information in at least one SN message of the at least one conditional SN procedure (e.g., event 308). The CU at block 608 retrieves an RRC message from each of the plurality of CG-Config IEs and generates a conditional configuration including the RRC message. The CU at block 610 assigns a configuration ID for each of the conditional configuration. The CU at block 612 transmits at least one RRC reconfiguration message including the conditional configurations and the configuration IDs to the UE via the DU (e.g., events 310 and 312). At block 614, the CU receives at least one RRC Reconfiguration complete message from the UE via the DU in response to the at least one RRC reconfiguration message (e.g., events 314 and 316). At block 616, the CU receives a first RRC Reconfiguration complete message including a first configuration ID from the UE via the DU (e.g., events 324 and 326). The CU at block 618 determines (e.g., identifies or selects) a first SN restriction information from the plurality of SN restriction in accordance with the first configuration ID. The CU at block 620 transmits a CU-to-DU message including the first SN restriction information to the DU (e.g., event 334).

In some implementations, the CU receives, from the candidate SN, at least one coordination information in the at least one SN message. In such implementations, the CU determines (e.g., identifies or selects) a first coordination information from the at least one coordination information in accordance with the first configuration ID. The CU then includes the (first) coordination information in the CU-to-DU message.

In other implementations, the candidate SN applies a single coordination information for the C-PSCells so that the CU receives the coordination information from the candidate SN. In such cases, the CU includes the coordination information in the CU-to-DU message.

In some implementations, the CU at block 620 can include MN restriction information in the CU-to-DU message.

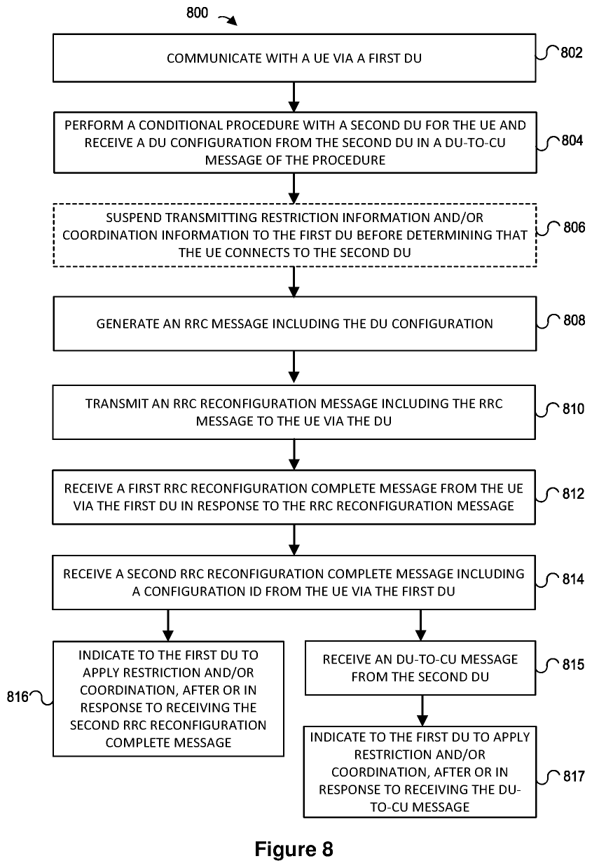

Turning to FIG. 7, a method 700 where an MN-CU (e.g., the CU 172 of the MN 104A), performs a conditional SN procedure with a candidate SN (e.g., the C-SN 106A) for a UE (e.g., the UE 102) is described. During the method 700, the MN-CU determines when to transmit multi-connectivity coordination information based on whether an SN procedure is conditional or immediate.

The method 700 starts at block 702 where the CU communicates with a UE via a DU. The CU at block 704 performs an SN procedure (e.g., SN addition procedure or SN modification procedure) with an SN for the UE and receives a CG-Config IE from the SN in an SN message of the SN procedure (e.g., event 308). The CU at block 706 determines whether the SN procedure is for an immediate SN procedure or a conditional SN procedure. If the SN procedure is for an immediate SN procedure, the flow proceeds to block 708 where the CU transmits a CU-to-DU message including restriction information and/or coordination information to the DU in response to receiving the SN message. If the SN procedure is for a conditional SN procedure, the flow proceeds to block 710 where the CU suspends transmitting restriction information and/or coordination information to the DU in response to receiving the SN message. The flow can then proceed from block 710 to block 714 where the CU receives, from the UE via the DU, an RRC Reconfiguration complete message indicating that the UE connected the SN (e.g., events 324 and 326). The flow then proceed to block 716 where the CU indicates to the DU to apply restriction and/or coordination information, after or in response to receiving the RRC reconfiguration complete message (e.g., event 334). Alternatively, the flow after block 710 can proceed to block 715 where the CU receives an interface message from the SN (e.g., event 332). The flow then proceeds to block 717 where the CU indicates to the DU to apply restriction and/or coordination information, after or in response to receiving the interface message (e.g., event 334).

Referring next to FIG. 8, a method 800 where a CU (e.g., the CU 172 of the MN 104A), performs a conditional procedure with a candidate DU (e.g., the C-DU 174B) for a UE (e.g., the UE 102) is described. The method 800 is similar to the method 500, except that conditional procedure is performed within the same base station, which operates as both the MN and the C-SN.

The method 800 starts at block 802 where the CU communicates with a UE via a first DU (i.e., an M-DU). The CU at block 804 performs a conditional procedure (e.g., CPA or CPC) with a second DU (i.e., a C-DU) for the UE and receives a DU configuration from the second DU in a DU-to-CU message of the procedure (e.g., events 405 and 407). The CU at block 806 may suspend transmitting restriction information and/or coordination information to the first DU before determining that the UE connects to the second DU. The CU at block 808 generates an RRC message including the DU configuration. At block 810, the CU transmits an RRC reconfiguration message including the RRC message to the UE via the DU (e.g., events 310 and 312, or 494). The CU at block 812 receives a first RRC reconfiguration complete message from the UE via the DU in response to the RRC reconfiguration message (e.g., events 314 and 316, or 494). The CU at block 814 receives a second RRC Reconfiguration complete message including a configuration ID from the UE via the first DU (e.g., events 324 and 326, or 424 and 426). The flow can then proceed to block 816 where the CU indicates to the first DU to apply restriction and/or coordination information, after or in response to receiving the second RRC reconfiguration complete message (e.g., event 434). Alternatively, after block 814, the flow can proceed to block 815 where the CU receives a DU-to-CU message from the second DU (e.g., event 431). The flow can then proceed to block 817 where the CU indicates to the first DU to apply restriction and/or coordination information, after or in response to receiving the DU-to-CU message (e.g., event 434).

Referring next to FIG. 9, a method 900 where a CU (e.g., the CU 172 of the MN 104A), performs a conditional procedure with a candidate DU (e.g., the C-DU 174B) for a UE (e.g., the UE 102) is described. The method 900 is similar to the method 600, except that conditional procedure is performed within the same base station, which operates as both the MN and the C-SN.

The method 900 starts at block 902 where the CU communicates with a UE via a first DU (i.e., an M-DU). The CU at block 904 performs at least one conditional procedure (e.g., CPA or CPC) with a second DU (i.e., a C-DU) for the UE (e.g., event 405). The CU at block 906 receives, from the second DU, a plurality of DU configurations and a plurality of SN restriction information in at least one DU-to-CU message of the at least one conditional procedure (e.g., event 407). For each of the plurality of DU configurations, the CU at block 908 generates an RRC message include the DU configuration and generates a conditional configuration including the RRC message. The CU at block 910 assigns a configuration ID for each of the conditional configurations. The CU at block 912 transmits at least one RRC reconfiguration message including the conditional configurations and the configuration IDs to the UE via the first DU (e.g., events 310 and 312, or 494). At block 914, the CU receives at least one RRC reconfiguration complete message from the UE via the first DU in response to the at least one RRC reconfiguration message (e.g., events 314 and 316, or 494). At block 916, the CU receives a first RRC reconfiguration complete message including a first configuration ID from the UE via the first DU (e.g., events 424 and 426). The CU at block 918 determines (e.g., identifies or selects) a first SN restriction information from the plurality of SN restriction in accordance with the first configuration ID. The CU at block 920 transmits a CU-to-DU message including the first SN restriction information to the first DU (e.g., event 434).

In some implementations, the CU receives, from the second DU, at least one coordination information in the at least one DU-to-CU message. In such implementations, the CU determines (e.g., identifies or selects) first coordination information from the at least one coordination information in accordance with the first configuration ID. The CU then includes the first coordination information in the CU-to-DU message.

In other implementations, the second DU applies a single coordination information for the C-PSCells so that the CU receives the coordination information from second DU. In such cases, the CU includes the coordination information in the CU-to-DU message.

In some implementations, the CU at block 920 can include MN restriction information in the CU-to-DU message.

Turning to FIG. 10, a method 1000 where a CU (e.g., the CU 172 of the MN 104A), performs a conditional procedure with a candidate DU (e.g., the C-DU 174B) for a UE (e.g., the UE 102) is described. The method 1000 is similar to the method 700, except that conditional procedure is performed within the same base station, which operates as both the MN and the C-SN.

The method 1000 starts at block 1002 where the CU communicates with a UE via a first DU (i.e., an M-DU). The CU at block 1004 performs a UE context procedure (e.g., UE context setup procedure or UE context modification procedure) with a second DU (i.e., a C-DU) for the UE and receives, from the second DU, a DU configuration from the second DU in a DU-to-CU message of the UE context procedure (e.g., event 407). The CU at block 1006 determines whether the UE context procedure is for an immediate UE context procedure or a conditional UE context procedure. If the UE context procedure is for an immediate UE context procedure, the flow proceeds to block 1008 where the CU transmits a CU-to-DU message including restriction information and/or coordination information to the first DU in response to receiving the DU-to-CU message. If the UE context procedure is for a conditional UE context procedure, the flow proceeds to block 1010 where the CU suspends transmitting restriction information and/or coordination information to the first DU in response to receiving the SN message. In some cases, the flow proceeds from block 1010 to block 1014 where the CU receives, from the UE via the first DU, an RRC reconfiguration complete message indicating that the UE connected to the second DU (e.g., events 424 and 426). The flow then proceeds to block 1016 where the CU indicates to the DU to apply restriction and/or coordination information, after or in response to receiving the RRC reconfiguration complete message (e.g., event 434). Alternatively, after block 1010, the flow can proceed to block 1015 where the CU receives a DU-to-CU message from the second DU (e.g., event 431). The flow then proceeds to block 1017 where the CU indicates to the DU to apply restriction and/or coordination information, after or in response to receiving the DU-to-CU message (e.g., event 434).

FIG. 11 illustrates a method 1100 that may involve either an immediate procedure or a conditional procedure. In scenarios in which the method 1100 is used to support a conditional procedure, the method 1100 is an alternative technique to those discussed above. In particular, during the method 1100, a CU may transmit restriction and/or coordination information to the DU prior to determining to which candidate node the UE connects. During the method 1100, a CU (e.g., the CU 172 of the MN 104A), performs a (conditional) procedure with a (candidate) RAN node (e.g., the C-SN 106A or the C-DU 174B) for a UE (e.g., the UE 102).

The method 1100 starts at block 1102 where the CU communicates with a UE via a DU. The CU at block 1104 configures a RAN node as a (candidate) serving RAN node for the UE (e.g., event 392 or 492). The CU at block 1106 indicates to the DU to apply restriction and/or coordination information, after or in response to configuring the RAN node as a (candidate) serving RAN node for the UE (e.g., event 307). At a later time, the CU at block 1108 releases the (candidate) serving RAN node for the UE. For example, in the case of a candidate RAN node, the CU may determine that the UE has connected to a different candidate node, and therefore releases the candidate RAN node. In another example, in the case of the candidate RAN node, the CU may determine that the candidate RAN node is no longer suitable for the UE to connect to, and therefore releases the candidate RAN node. At block 1110, the CU indicates to the DU to stop applying the restriction and/or coordination information, after or in response to releasing the (candidate) serving RAN node for the UE (e.g., event 334 in scenarios in which the CU 172 transmitted 307 the CU-to-DU message). Continuing the example from above, the CU can indicate to the DU to discard (i.e., release or stop applying) restriction and/or coordination information for the candidate RAN node, and retain restriction and/or coordination information for the different candidate node to which the UE connected.

In some implementations, the CU can transmit to the DU a CU-to-DU message indicating the DU to stop applying the restriction and/or coordination information to communicate with the UE. In some implementations, the DU can release the restriction information and/or coordination information in response to the CU-to-DU message.

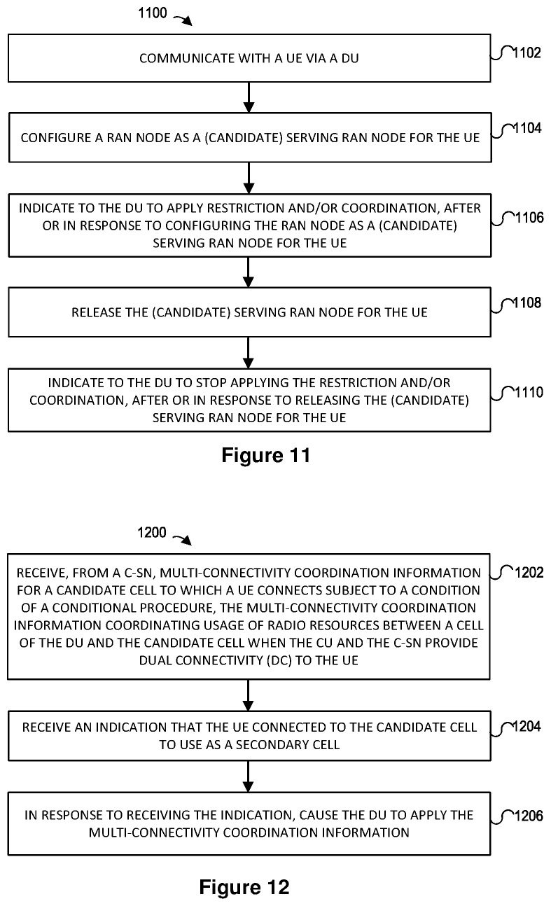

Referring next to FIG. 12, FIG. 12 illustrates a method 1200 for managing multi-connectivity information (i.e., restriction and/or coordination information), which can be implemented in a CU (e.g., the CU 172) of a distributed base station (e.g., the base station 104A) including the CU and a DU (e.g., the DU 174). At block 1202, the CU receives, from a candidate secondary node, multi-connectivity coordination information for a candidate cell to which a UE connects subject to a condition of a conditional procedure, the multi-connectivity coordination information coordinating usage of radio resources between a cell of the DU and the candidate cell when the CU and the candidate secondary node provide dual connectivity (DC) to the UE (e.g., event 308, 332, 407, or 431). At block 1204, the CU receives an indication that the UE connected to the candidate cell to use as a secondary cell (e.g., event 326, 332, 426, or 431). At block 1206, in response to receiving the indication, the CU causes the DU to apply the multi-connectivity coordination information (e.g., event 334 or 434).

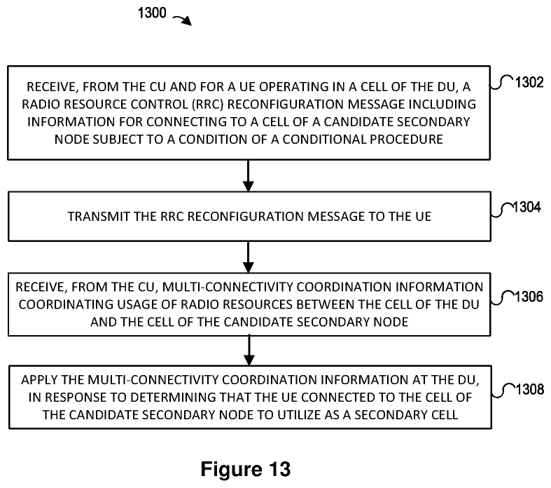

Turning to FIG. 13, a DU (e.g., the DU 174) of a distributed base station (e.g., the base station 104A) including the DU and a CU (e.g., the CU 172) can implement a method 1300 for managing multi-connectivity information. At block 1302, the DU receives, from the CU and for a UE operating in a cell of the DU, a radio resource control (RRC) reconfiguration message including information for connecting to a cell of a candidate secondary node subject to a condition of a conditional procedure. At block 1304, the DU transmits the RRC reconfiguration message to the UE. At block 1306, the DU receives, from the CU, multi-connectivity coordination information coordinating usage of radio resources between the cell of the DU and the cell of the candidate secondary node. At block 1308, the DU applies the multi-connectivity coordination information at the DU, in response to determining that the UE connected to the cell of the candidate secondary node.

The list of examples below reflects a variety of the embodiments explicitly contemplated herein.

Example 1. A method is implemented in a CU a disaggregated base station including the CU and a DU. The method includes receiving, by the CU from a candidate SN, multi-connectivity coordination information for a candidate cell to which a UE connects subject to a condition of a conditional procedure. The multi-connectivity coordination information coordinates usage of radio resources between a cell of the DU and the candidate cell, when the CU and the candidate SN provide DC to the UE. The method further includes receiving, by the CU, an indication that the UE connected to the candidate cell to use as a secondary cell, and, in response to the receiving of the indication, causing the DU to apply the multi-connectivity coordination information.

Example 2. The method of example 1, wherein the causing includes: in response to the receiving of the indication, transmitting the multi-connectivity coordination information to the DU.

Example 3. The method of example 2, wherein the receiving of the multi-connectivity coordination information includes receiving different respective multi-connectivity coordination information for a plurality of candidate cells in a candidate cell list; wherein the secondary cell is one of the plurality of candidate cells.

Example 4. The method of example 3, wherein the transmitting of the multi-connectivity coordination information includes: omitting, from a message including the multi-connectivity coordination information for the secondary cell, the multi-connectivity coordination information for a remainder of the candidate cell list.

Example 5. The method of example 1, further comprising: prior to receiving the indication, transmitting the multi-connectivity coordination information to the DU.

Example 6. The method of claim of claim 5, wherein the receiving includes: receiving different respective multi-connectivity coordination information for a plurality of candidate cells in a candidate cell list; wherein: the secondary cell is one of the plurality of candidate cells, and the causing of the DU to apply the multi-connectivity coordination information includes transmitting, to the DU and in response to receiving the indication, an instruction to discard the multi-connectivity coordination information for a remainder of the candidate cell list.

Example 7. The method of example 3, 4, or 6, wherein the candidate cell list is formatted as an CG-CandidateList information element (IE).

Example 8. The method of any of the preceding examples, wherein the receiving of the indication includes receiving a notification from the candidate SN.

Example 9. The method of any of examples 1-7, wherein the receiving of the indication includes: receiving, from the UE, a message indicating that the UE completed a reconfiguration of the radio resources for the secondary cell, the message including an identifier of the secondary cell; and forwarding the message to the candidate SN.

Example 10. The method of any of the preceding examples, wherein the receiving of the multi-connectivity coordination information includes receiving an SN addition request acknowledgement message.

Example 11. The method of example 10, wherein the conditional procedure is conditional primary secondary cell (PSCell) addition.

Example 12. The method of example 10, wherein the conditional procedure is conditional PSCell change.

Example 13. The method of any of examples 1-9, wherein receiving the coordination information includes receiving an SN change required message.

Example 14. The method of any of the preceding claims, wherein: the DU is a first DU, and the candidate SN is a second DU of the disaggregated base station.

Example 15. The method of any examples 1-13, wherein the candidate SN is a peer base station or a DU of the peer base station.

Example 16. The method of any of the preceding examples, wherein the multi-connectivity coordination information includes one or more power coordination parameters.

Example 17. The method of any of the preceding examples, wherein the multi-connectivity coordination information includes one or more discontinuous reception (DRX) parameters.

Example 18. The method of any of the preceding examples, wherein the multi-connectivity coordination information includes master node (MN) restriction information related to a maximum uplink power the UE can use to communicate with the disaggregated base station.

Example 19. The method of any of the preceding examples, wherein the multi-connectivity coordination information includes secondary node (SN) restriction information related to a maximum uplink power the UE can use to communicate with the SN.

Example 20. A method is implemented in a DU of a disaggregated base station including the DU and a CU. The method includes receiving, by the DU from the CU and for a UE operating in a cell of the DU, an RRC reconfiguration message including information for connecting to a cell of a candidate secondary node subject to a condition of a conditional procedure; transmitting, by the DU, the RRC reconfiguration message to the UE; receiving, by the DU from the CU, multi-connectivity coordination information coordinating usage of radio resources between the cell of the DU and the cell of the candidate secondary node; and applying the multi-connectivity coordination information at the DU, in response to determining that the UE connected to the cell of the candidate secondary node to utilize as a secondary cell.

Example 21. The method of example 20, wherein the receiving of the multi-connectivity coordination information includes receiving respective multi-connectivity coordination information for a plurality of candidate cells in a candidate cell list; and receiving an indication to discard the multi-connectivity coordination information for all candidate cells in the candidate cell list except for the secondary cell.

Example 22. The method of example 20, wherein the receiving of the multi-connectivity coordination information includes: receiving, by the DU from the UE, an RRC reconfiguration complete message; transmitting, by the DU to the CU, the RRC reconfiguration complete message; and subsequently to transmitting the RRC reconfiguration complete message, receiving an indication of the secondary cell from the CU.

Example 23. A network node comprising processing hardware and configured to implement a method according to any one of the preceding examples.

The following description may be applied to the description above.

In some implementations, “message” is used and can be replaced by “information element (IE)”. In some implementations, “IE” is used and can be replaced by “field”. In some implementations, “configuration” can be replaced by “configurations” or the configuration parameters.

A user device in which the techniques of this disclosure can be implemented (e.g., the UE 102) can be any suitable device capable of wireless communications such as a smartphone, a tablet computer, a laptop computer, a mobile gaming console, a point-of-sale (POS) terminal, a health monitoring device, a drone, a camera, a media-streaming dongle or another personal media device, a wearable device such as a smartwatch, a wireless hotspot, a femtocell, or a broadband router. Further, the user device in some cases may be embedded in an electronic system such as the head unit of a vehicle or an advanced driver assistance system (ADAS). Still further, the user device can operate as an internet-of-things (IoT) device or a mobile-internet device (MID). Depending on the type, the user device can include one or more general-purpose processors, a computer-readable memory, a user interface, one or more network interfaces, one or more sensors, etc.

Certain embodiments are described in this disclosure as including logic or a number of components or modules. Modules may can be software modules (e.g., code, or machine-readable instructions stored on non-transitory machine-readable medium) or hardware modules. A hardware module is a tangible unit capable of performing certain operations and may be configured or arranged in a certain manner. A hardware module can comprise dedicated circuitry or logic that is permanently configured (e.g., as a special-purpose processor, such as a field programmable gate array (FPGA) or an application-specific integrated circuit (ASIC), a digital signal processor (DSP), etc.) to perform certain operations. A hardware module may also comprise programmable logic or circuitry (e.g., as encompassed within a general-purpose processor or other programmable processor) that is temporarily configured by software to perform certain operations. The decision to implement a hardware module in dedicated and permanently configured circuitry, or in temporarily configured circuitry (e.g., configured by software) may be driven by cost and time considerations.

When implemented in software, the techniques can be provided as part of the operating system, a library used by multiple applications, a particular software application, etc. The software can be executed by one or more general-purpose processors or one or more special-purpose processors.

1. A method implemented in a central unit (CU) of a disaggregated base station including the CU and a distributed unit (DU), the method comprising:
receiving, by the CU from a candidate secondary node (SN), multi-connectivity coordination information for a candidate cell to which a UE connects subject to a condition of a conditional procedure, the multi-connectivity coordination information coordinating usage of radio resources between a cell of the DU and the candidate cell when the CU and the candidate SN provide dual connectivity (DC) to the UE;
receiving, by the CU, an indication that the UE connected to the candidate cell to use as a secondary cell; and
in response to the receiving of the indication, causing the DU to apply the multi-connectivity coordination information.

2. The method of claim 1, wherein the causing includes:
in response to the receiving of the indication, transmitting the multi-connectivity coordination information to the DU.

3. The method of claim of claim 2, wherein the receiving of the multi-connectivity coordination information includes:
receiving different respective multi-connectivity coordination information for a plurality of candidate cells in a candidate cell list;
wherein the secondary cell is one of the plurality of candidate cells; and
wherein the transmitting of the multi-connectivity coordination information includes:
omitting, from a message including the multi-connectivity coordination information for the secondary cell, the multi-connectivity coordination information for a remainder of the candidate cell list.

4. The method of claim 1, further comprising:
prior to receiving the indication, transmitting the multi-connectivity coordination information to the DU.

5. The method of claim of claim 4, wherein the receiving includes:
receiving different respective multi-connectivity coordination information for a plurality of candidate cells in a candidate cell list;
wherein:
the secondary cell is one of the plurality of candidate cells, and
the causing of the DU to apply the multi-connectivity coordination information includes transmitting, to the DU and in response to receiving the indication, an instruction to discard the multi-connectivity coordination information for a remainder of the candidate cell list.

6. The method of claim 1, wherein the receiving of the indication includes:
receiving a notification from the candidate SN.

7. The method of claim 1, wherein the receiving of the indication includes:
receiving, from the UE, a message indicating that the UE completed a reconfiguration of the radio resources for the secondary cell, the message including an identifier of the secondary cell; and
forwarding the message to the candidate SN.

8. The method of claim 1, wherein the receiving of the multi-connectivity coordination information includes one of:
receiving an SN addition request acknowledgement message, or

9. The method of claim 10, wherein the conditional procedure is one of:
conditional primary secondary cell (PSCell) addition, or
conditional PSCell change.

10. The method of claim 1, wherein:
the DU is a first DU, and
the candidate SN is a second DU of the disaggregated base station.

11. The method of claim 1, wherein the multi-connectivity coordination information includes one or more of:
(i) a power coordination parameter,
(ii) a discontinuous reception (DRX) parameter,
(iii) MN restriction information related to a maximum uplink power the UE can use to communicate with the disaggregated base station,
(iv) S restriction information related to a maximum uplink power the UE can use to communicate with the SN.

12. A method implemented in a distributed unit (DU) of a disaggregated base station including the DU and a central unit (CU), the method comprising:
receiving, by the DU from the CU and for a UE operating in a cell of the DU, a radio resource control (RRC) reconfiguration message including information for connecting to a cell of a candidate secondary node subject to a condition of a conditional procedure;
transmitting, by the DU, the RRC reconfiguration message to the UE;
receiving, by the DU from the CU, multi-connectivity coordination information coordinating usage of radio resources between the cell of the DU and the cell of the candidate secondary node; and
applying the multi-connectivity coordination information at the DU, in response to determining that the UE connected to the cell of the candidate secondary node to utilize as a secondary cell.

13. The method of claim 12, wherein the receiving of the multi-connectivity coordination information includes:
receiving respective multi-connectivity coordination information for a plurality of candidate cells in a candidate cell list; and
receiving an indication to discard the multi-connectivity coordination information for all candidate cells in the candidate cell list except for the secondary cell.

14. The method of claim 12, wherein the receiving of the multi-connectivity coordination information includes:
receiving, by the DU from the UE, an RRC reconfiguration complete message;
transmitting, by the DU to the CU, the RRC reconfiguration complete message; and
subsequently to transmitting the RRC reconfiguration complete message, receiving an indication of the secondary cell from the CU.

15. A central unit (CU) of a disaggregated base station including the CU and a distributed unit (DU) comprising:
a transceiver; and
processing hardware; the CU to:
receive, by the CU from a candidate secondary node (SN), multi-connectivity coordination information for a candidate cell to which a UE connects subject to a condition of a conditional procedure, the multi-connectivity coordination information coordinating usage of radio resources between a cell of the DU and the candidate cell when the CU and the candidate SN provide dual connectivity (DC) to the UE,
receive, by the CU, an indication that the UE connected to the candidate cell to use as a secondary cell, and
in response to the receiving of the indication, cause the DU to apply the multi-connectivity coordination information.

16. The CU of claim 15, wherein to cause the DU to apply the multi-connectivity coordination information, the CU is configured to:
in response to the receiving of the indication, transmit the multi-connectivity coordination information to the DU.

17. The CU of claim 16, wherein to receive the multi-connectivity coordination information, the CU is configured to:
receive different respective multi-connectivity coordination information for a plurality of candidate cells in a candidate cell list;
wherein the secondary cell is one of the plurality of candidate cells; and
wherein the transmitting of the multi-connectivity coordination information includes:
omitting, from a message including the multi-connectivity coordination information for the secondary cell, the multi-connectivity coordination information for a remainder of the candidate cell list.

18. The CU of claim 15, further configured to:
prior to receiving the indication, transmit the multi-connectivity coordination information to the DU.

19. The CU of claim 18, further configured to:
receive different respective multi-connectivity coordination information for a plurality of candidate cells in a candidate cell list;
wherein:
the secondary cell is one of the plurality of candidate cells, and
the causing of the DU to apply the multi-connectivity coordination information includes transmitting, to the DU and in response to receiving the indication, an instruction to discard the multi-connectivity coordination information for a remainder of the candidate cell list.

20. The CU of claim 14, wherein to receiving the indication includes, the CU is configured to:
receive a notification from the candidate SN.
